(19) United States
(12) Patent Application Publication
(10) Pub. No.: US 2014/0059051 A1
(43) Pub. Date: Feb. 27, 2014

(54) APPARATUS AND SYSTEM FOR AN INTEGRATED RESEARCH LIBRARY

(71) Applicant: MARK WILLIAM GRAVES, JR., INDIANAPOLIS, IN (US)

(72) Inventor: MARK WILLIAM GRAVES, JR., INDIANAPOLIS, IN (US)

(21) Appl. No.: 14/052,754

(22) Filed: Oct. 13, 2013

Related U.S. Application Data
(63) Continuation-in-part of application No. 13/591,750, filed on Aug. 22, 2012.

(51) Int. Cl. G06F 17/30

(52) U.S. Cl. CPC G06F 17/3007
USPC 707/740

(57) ABSTRACT

A process for automated generation and storage of an organized form of comparisons amongst research resources on a set of user defined categories. The process creates an organized cross reference for resource annotations by their source and comparison category. User input enables the program to create, read, update, and destroy resources, comparison categories, and resource annotations and their associated information. The process eliminates redundancy in creation of physical and digital storage and organization systems for research resources, comparison categories, and annotations.

### CROSS REFERENCE TO RELATED APPLICATIONS

This application claims the benefit of U.S. Nonprovisional application Ser. No. 13/591,750 filed on Aug. 22, 2012. The entire disclosure of that application is hereby incorporated by reference into the disclosure of this document is if fully stated herein.

### STATEMENT REGARDING FEDERALLY SPONSORED RESEARCH

Not Applicable.

### TECHNICAL FIELD OF THE INVENTION

The present invention relates to a system that combines a computer apparatus and process for organizing research resources, comparison categories, and resource annotations, and particularly to the automated generation and storage of an organized form of comparison amongst the resources on a set of user defined categories.

### BACKGROUND OF THE INVENTION

In doing research according to the scientific method, researchers often base their research on the findings of other researchers. This process involves analysis of published and unpublished but available resources across a set of comparison categories. Researchers often perform this process manually using a combination of searching for resources, storage, accumulation, and organization of resources, and generation and storage of comparisons across categories. Resources can be bodies of information comprising any type of multimedia, including text, video, audio, and graphic, or a combination of the aforementioned, in a number of embodiments. Examples include published and unpublished articles, books, magazines, research results, etc. Comparison categories can be abstract labels for a logical set of attributes for information referred to or contained in resources which is acquired/accumulated/analyzed by researchers.

Searching for information entails researchers using computerized search engines, libraries, word of mouth, references within resource citations, and other methods to find resources of interest on which to base further research.

Storage and organization of resources entails researchers digitally or physically storing and organizing resources. Physically, this includes creating a physical representation of the resource then creating a physical organization system for these physical representations of resources. For example, scientific journal articles can be printed or copied, then creating a physical organization system such as a hanging file folder system. Digitally, this includes downloading or copying resources using a computer and then creating a digital organization system within a computer for the equivalent digital representations of the resources. Accumulation of resources can include both physical and digital components mentioned.

Storage and organization of comparisons can also include a combination of digital and physical processes. After acquiring a particular resource, researchers examine the resource for information pertaining to their comparison categories of interest. Finally, researchers record the acquired information across categories for comparison. Again, this can consists of a combination of physical and digital systems of storage and organization. Typically, this is created as a digital, physical, or combination tabled format for ease of reference.

Without a standard tool for the searching, organizing, and storing the information using a computer system, the process is time consuming due to its repetition. Researchers may repetitively search for a resource from which they have previously acquired information. Researchers may have to recreate digital and/or physical organization and storage systems for resources, comparison categories, and acquired information cross referenced from the resources and comparison categories. Thus, researchers spend their time doing repetitive tasks instead of performing other non-repetitive tasks in research. The current invention addresses this problem by providing a computerized tool for researchers to automate this repetitive organization and storage process.

Additionally, resources used for analysis across comparison categories may include a combination of Unstructured and Structured Information. Unstructured Information refers to information which may not have a pre-defined data model, may not be organized in a pre-defined manner, or Semi/Highly Structured Information which is not structured in a manner useful for comparison across categories. Structured Information, on the other hand, refers to information organized in a pre-defined manner, based on a pre-defined data model, useful for comparison across categories. Individual researchers may then have to transform the Unstructured Information to Structured Information before it can be usefully compared. Thus, researchers spend their time doing repetitive tasks instead of performing other non-repetitive tasks in research. The current invention addresses this problem by providing a method and computerized tool for creation of linked data structures which can be shared amongst researchers to automate the repetitive process of creating Structured Information from Unstructured Information.

### SUMMARY OF THE INVENTION

In accordance with the various embodiments of the present invention, this invention essentially comprises a system for creating, retrieving, updating, and deleting resources, comparison categories for the resources, and resource annotations using a computer system. Users input resources, comparison categories, and resource annotations through one or more methods. Certain embodiments of the invention provide a computer apparatus and method for organizing resources, comparison categories, and resource annotations. The invention stores this information and provides a standard input and output organization system to address the problem of repetition in storage and organization. In the present embodiment, a computerized version of the system can automatically generate and store an organized form of comparison amongst the resources on a set of user defined comparison categories and allows the user to input comparison categories and resources to generate a standard format for cross referencing resource annotations. User input defines a set of resources to compare and also defines a set of comparison categories as well as defining the annotations pertaining to each resource-comparison category combination. User input to the invention creates linked data structures which effectively transform Unstructured Information into Structured Information which can be used in certain embodiments of the invention to address the problem of repetition in this transformation process through sharing of the linked data structures. Also in the present embodiment, the invention stores this information, organizes it, and presents it in a standard format on a computerized data storage system while also providing methods to provide for most of the typical methods of interacting with these annotations, resources, and comparison categories, such as creation, reading, updating, organizing, and deleting. Certain embodiments of the invention allow for creation of new resources within the invention with methods to for creating, reading, updating, organizing, and deleting references to annotations, resources, comparison categories and their associated information generated within the system. One such embodiment could include word processing functionality with the ability to insert annotations, resources, comparison categories and their associated information. In such an embodiment, the invention could include the capability to automatically and/or manually track and manage both in text citations and bibliographic entries according to any number of citation styles. In another embodiment of the invention, the invention could provide functionality to export and/or share annotations, resources, comparison categories and their associated information between or amongst a selected group of individuals. In such an embodiment, the invention could include a mechanism to publish their annotations, resources, comparison categories, and their associated information which could be accessed by a number of researchers with or without user access control.

It will be appreciated by those of skill in the art that establishing the embodiments as described within the preceding paragraph requires extensive use of program instructions and processes to establish baseline operating parameters for embodiments of the present invention. It will also be appreciated that certain embodiments of the present invention require vast amounts of stored data that include complicated correlations between new information and historical information related to old data, deleted data, updated data, and new data. Additionally, for certain embodiments of the present invention to work for their intended purposes, all the functional elements must be retrievable and updateable in an environment that must allow a large number of research collaborators to quickly access the basic information generated and correlated within the present embodiments. With these particular requirements in mind, it will be understood that embodiments of the present invention must incorporate a set of computer implemented steps and methods that must be processed by a microprocessor-equipped computing device having computer-readable storage medium.

### DESCRIPTION OF THE DRAWINGS

In the accompanying drawings which form part of the specification:

FIG. 1 shows a flow chart of the Initial Program Access and User Access Control for one embodiment of the present invention.

FIG. 2 shows a flow chart of the Three Program Methods Displayed in Parallel to All Other Methods for one embodiment of the present invention.

FIG. 3 shows a flow chart of the Methods for Managing a User's Files and Variables for one embodiment of the present invention.

FIG. 4 shows a flow chart of the Method to Add a File to a User's Library for one embodiment of the present invention.

FIG. 5 shows a flow chart of the Method for Viewing a File for one embodiment of the present invention.

FIG. 6 shows a flow chart of the Method for Editing Descriptive Information about a File for one embodiment of the present invention.

FIG. 7 shows a flow chart of the Method for Removing a File from a User's Library for one embodiment of the present invention.

FIG. 8—shows a flow chart of the Method for Adding a New Variable to a User's Library for one embodiment of the present invention.

FIG. 9 shows a flow chart of the Method for Viewing a Variable for one embodiment of the present invention.

FIG. 10 shows a flow chart of the Method for Editing Descriptive Information about a Variable for one embodiment of the present invention.

FIG. 11 shows a flow chart of the Method for Removing a Variable from a User's Library.

FIG. 12 shows a flow chart of the Methods for Managing a User's Resource Reviews for one embodiment of the present invention.

FIG. 13 shows a flow chart of the Method for Creating a New Resource Review for one embodiment of the present invention.

FIG. 14 shows a flow chart of the Methods for Managing Files, Annotations, and Variables in a Resource Review for one embodiment of the present invention.

FIG. 15 shows a flow chart of the Methods for Editing Descriptive Information about a Resource Review for one embodiment of the present invention.

FIG. 16 shows a flow chart of the Method for Removing a Resource Review for one embodiment of the present invention.

FIG. 17 shows a flow chart of the Available Methods to Add File(s) to a Resource Review for one embodiment of the present invention.

FIG. 18 shows a flow chart of the Method for Adding a File from Outside the Program to a Resource Review for one embodiment of the present invention.

FIG. 19 shows a flow chart of the Method for Adding Existing File(s) from the Program to a Resource Review for one embodiment of the present invention.

FIG. 20 shows a flow chart of the Available Methods to Add Variable(s) to a Resource Review for one embodiment of the present invention.

FIG. 21 shows a flow chart of the Method for Adding a New Variable to Resource Review for one embodiment of the present invention.

FIG. 22 shows a flow chart of the Method for Adding an Existing Variable from the Program to a Resource Review for one embodiment of the present invention.

FIG. 23 shows a flow chart of the Method for Editing Descriptive Information about a Variable for one embodiment of the present invention.

FIG. 24 shows a flow chart of the Method for Removing a Variable from a Resource Review for one embodiment of the present invention.

FIG. 25 shows a flow chart of the Method for Removing a File from a Resource Review for one embodiment of the present invention.

FIG. 26 shows a flow chart of the Method for Viewing & Interacting with a File and its Annotations in a Resource Review for one embodiment of the present invention.

FIG. 27 shows a flow chart of the Method for Adding an Annotation in a Resource Review for one embodiment of the present invention.

FIG. 28 shows a flow chart of the Method for Editing an Annotation for one embodiment of the present invention.

FIG. 29 shows a flow chart of the Method for Removing an Annotation for one embodiment of the present invention.

FIG. 30 shows a flow chart of the Method for Viewing and Interacting with a Specific Annotation within a File for one embodiment of the present invention.

FIG. 31 shows a flow chart of the Diagram of Cascading Entity Relationships for one embodiment of the present invention.

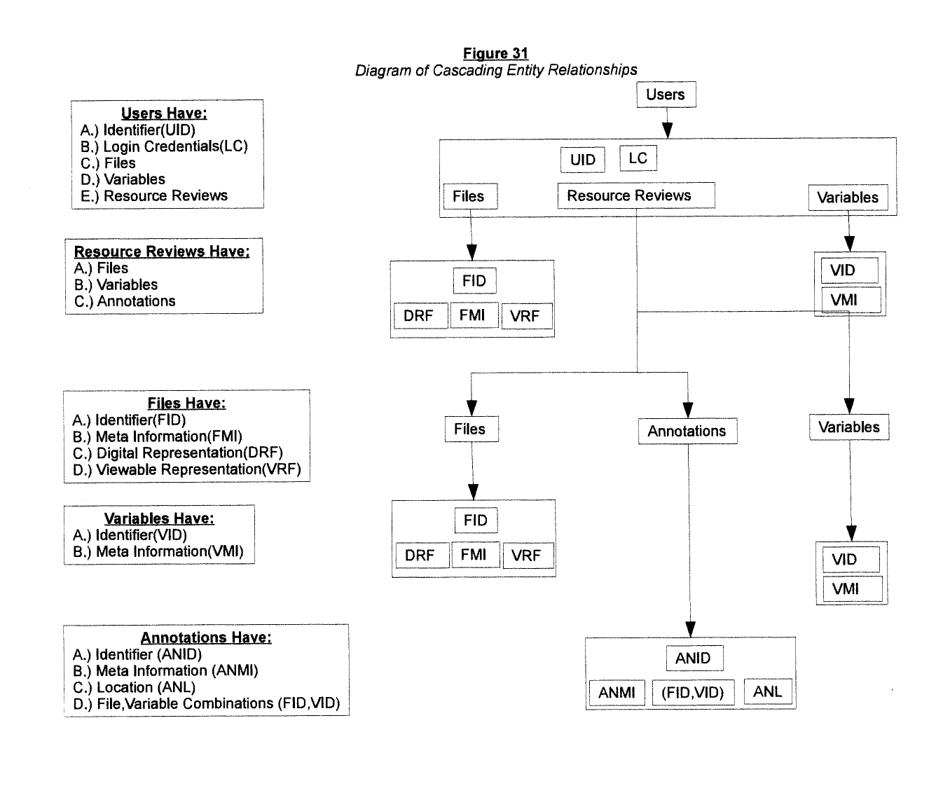

Corresponding reference numerals indicate corresponding steps or parts throughout the several figures of the drawings.

While one embodiment of the present invention is illustrated in the above referenced drawings and in the following description, it is understood that the embodiment shown is merely one example of a single preferred embodiment offered for the purpose of illustration only and that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION OF A PREFERRED EMBODIMENT OF THE INVENTION

A preferred embodiment of the present invention is illustrated in drawings and figures contained within this application. More specifically, a preferred embodiment of the present invention uses a specifically programmed software process that is installed onto a computer apparatus having an input device such as a keyboard or mouse, a display device such as a monitor, a data storage system for digitally storing the information and information recourse data, and a computational component for quickly conducting resource searches, organizing the resource search results, and for quickly responding to information queries input by an operator.

The following Abbreviations are used herein.

| ABBREVIATION | ACTUAL TERM |
|---|---|
| ANID | Annotation ID |
| ANMI | Annotation Meta Information |
| ANL | Annotation Location |
| DRF | Digital Representation of File |
| FID | File ID |
| FMI | File Meta Information |
| RRID | Resource Review Identifier |
| RRMI | Resource Review Meta Information |
| LC | Login Credentials |
| UID | User ID |
| VID | Variable ID |
| VMI | Variable Meta Information |
| VRF | Visual Representation of File |

### I. General Overview of Data and Program Structure:

A. Methods of Segregation and Association Amongst Information.

As described for the present embodiment, linkages are information comprising a method for the purpose of segregation of unrelated user input and program data, reference among related user input and program data, and retrieval of related user input and program data. For instance, herein Digital Representations of a File and File Meta Information are linked to a single File ID number. That means that the use of the ID number by the invention can be used to retrieve the linked Digital Representation of a file and File Meta Information of that specific File. In the present embodiment, the use of that same ID number would not retrieve an unlinked Digital Representation of a File or File Meta Information (Digital Representations and Meta Information of other files). This method is common to database driven applications.

An alternative embodiment of the present invention permits the operation of the present invention to segregate unrelated user input and program data, reference among related user input and program data, and retrieve related user input and program data by any method sufficient for these purposes. This is to say; while the current embodiments may be database driven, other embodiments could interact with existing programs which would use another method of association.

In the current embodiment certain preferred embodiments of the invention Files, Variables, Annotations and their Meta Information are segregated from one another. It will be understood by those skilled in the art that the nature of the linked data structures created within the program would allow for interlinking of and referencing amongst Files, Variables, Annotations, and their Meta-Information within the invention to increase its usefulness without compromising its essential functions. It will further be understood by those skilled in the art that the aforementioned processes could be augmented by User Access Control mechanisms to increase the invention's usefulness without compromising its essential functions. Thus, in another embodiment of the invention, the invention would compromise methods and processes for creating, reading, updating and deleting linkages as well as references to linkages between and amongst linked data structures. In such an embodiment, the invention may or may not comprise additional User Access Control mechanisms depending on the embodiment. For example but not as a limitation, an individual Variable's Variable Meta Information may comprise linkages to another Variable's Variable Meta Information to collaboratively construct Variable Meta-Information in a format similar to Wikipedia where references to other Variable Meta-Information is accessible from an individual Variable's Meta-Information. In another example Variable Meta-Information may include links to Files. In this manner, the usefulness of the invention in creating structured data from unstructured data is further increased.

B. Definition of User ID.

A User ID herein is information used for the purpose of segregation of and linking amongst a single User's input. In the current embodiment of the invention, the User ID is a unique numeral assigned to each User. It will be understood by those skilled in the art that the format for the User ID may also include alpha or alpha-numeric information as long as the User ID is unique within the present embodiment's User ID configuration.

In another embodiment of the invention, another method could be implemented including but not limited to physical and/or digital isolation of the system on a single computer and/or digital separation of the apparatus and method from other computer users, sufficient for the purposes of segregation of and linking amongst a single User's input.

In yet another embodiment of the invention, the embodiment could exclude use of a User ID such that the User ID would be considered a preset constant throughout the embodiment, and the further process would remain the same, thus satisfying the purposes of segregation of and linking amongst a single User's input.

The current embodiment of the invention is exemplified in a single user format. As such in the current embodiment of the invention, each single user's input is segregated. In another embodiment of the invention, further methods, processes, elements and/or external libraries may be incorporated to allow for multiple user collaboration in the essential processes and methods of the invention while still maintaining its overall purpose. It will be understood by those skilled in the art that these, methods, processes, elements and/or external libraries are commonly referred to as user access control mechanisms in multiple user applications. It will be further understood by those skilled in the art that user access control mechanisms are common to collaborative multiple user applications such as content management systems and social media platforms and will not impede the essential functions of the invention. It will be further understood to those skilled in the art that implementation of user access control mechanisms and multiple user collaboration would increase the usefulness of the invention by further reducing redundant efforts of individual users.

Because the current embodiment of the invention exemplifies a single user embodiment, there is no method for giving feedback to individual User's annotations, Variables, Files, and their Meta information. However, in another embodiment of the invention a method could be provided to accept multiple user feedback on a single User's Annotations, Variables, and Files. It will be understood by those skilled in the art that such a method is common to Social Networking applications as exemplified by Facebook's “Like” mechanism or the method of “Rate Up, Rate Down” employed by applications such as SourceForge. These additional methods would further increase the usefulness of the application without compromising its essential functions.

C. Definition of Login Credentials.

Login Credentials are user input information for the purpose of authorizing a user to input further information to embodiments of the invention. In the current embodiment of the invention, the user is presumed to have obtained Login Credentials during a period preceding use of the present embodiment for the purpose described herein.

In another embodiment of the invention, the computer apparatus and method described could include a method for assigning Login Credentials to an individual user.

In yet another alternative embodiment of the invention, the computer apparatus and method described could be physically and/or digitally isolated between individual users rendering the inclusion of the assignment of Login Credentials and a User ID unnecessary. In that embodiment, the User ID for an individual would be considered a preset constant, thus satisfying the purpose of segregation of and linking amongst a single User's input.

D. Definition of a File.

Files herein are information used for the purpose of segregation of and linking amongst a group comprising: a unique digital identifier for elements linked to the File (File ID), the actual computer data comprising the input research resource (Digital Representations of Files), descriptive information about the input computer data (File Meta Information), and a invention-displayable/user-viewable representation of their contents (Visual Representations of Files). A further purpose of a File is to allow cross referencing of a given resource with its annotations across comparison categories (Variables).

File ID's herein are information used for the purposes of unique identification as well as segregation of and linking amongst the Digital Representation of the File, File Meta Information, and the Visual Representation of the File. In the current embodiment of the invention, a File ID's is a unique numeral assigned to a group comprising: an input Digital Representation of a File, its File Meta Information, and the Visual Representation of the File. It will be understood by those skilled in the art that the format for the File ID may also include alpha or alpha-numeric information as long as the File ID is unique within the present embodiment's File ID configuration. A Digital Representation of File as used in certain embodiments is computer data used for the purpose of comprising the contents of the input File. In some embodiments, the Digital Representation of the File is the actual computer data comprising a research resource which is input to the invention. File Meta Information herein is information used for the purpose of describing the File. In the current embodiment, File Meta Information comprises the title of the input Digital Representation of the File extracted by the invention.

In another embodiment of the present invention, File Meta Information would comprise any information, including but not limited to, selections of text from a text file, title, author(s), abstract, publication date, publication/source journal, length, etc. sufficient for the purpose of describing the File.

In another embodiment of the invention, File Meta Information could be extracted from within the Digital Representation of the File via that embodiment of the present invention, an external computer library, manually input by the user or some combination thereof.

In yet another embodiment of the invention, descriptive information about the File could come from another source such that the embodiment of the invention or a library would somehow find the information and input it into embodiment of the invention. In this embodiment, either the embodiment or an external library would determine from the File a reference to an external data source and/or database. The embodiment or external library would then query the data source for further information using the reference, and input the retrieved information into the invention. It will be appreciated that this could happen automatically or with some form of user interaction and still remain within the scope of the present invention. An example of this would involve the embodiment of the invention or an external library extracting a PubMed ID number, querying the PubMed database, and returning the results of the query to the program of that embodiment of the invention.

Visual Representation of the File is computer data used for the purpose of allowing user viewing of the text and/or graphical contents of a File. The present embodiment of the invention uses text/graphical files as examples of Files. However, as certain multimedia data such as audio does not have a direct graphical representation, either the invention, another embodiment of the invention, or an external library may be required to convert the multimedia data into a visually representable form, such as a waveform, while still maintaining the purpose of the Visual Representation of the File. In the current embodiment of the invention, the Visual Representation of the File is generated by a library on input into the invention. In another embodiment of the invention, this step could be performed during the retrieval operation of the File in order to view and/or further interact with it.

In certain embodiments of the invention, the File, Digital Representation of File, and Visual Representation of File are considered distinct entities. In alternative embodiments of the invention, there could be any combination of such components sufficient for their combined purposes.

E. Definition of Variable.

Variables herein are information comprising: a unique identifier for elements linked to the Variable (Variable ID) and descriptive information about the logical set of attributes used for comparison by the User (Variable Meta Information). It is used for the purposes of segregation of unrelated and linking amongst a related logical set of attributes of information which may be acquired in Files.

Variable ID's herein are information used for the purposes of unique identification of a Variable as well as segregation of unrelated and linking amongst related Variable ID's and Variable Meta Information. In the current embodiment of the invention, a Variable ID's is a unique numeral assigned to information comprising the input description of the comparison category (Variable Meta Information). It will be understood by those skilled in the art that the format for the Variable ID may also include alpha or alpha-numeric information as long as the Variable ID is unique within the present embodiment's Variable ID configuration.

Variable Meta Information herein is information used for the purpose of describing the comparison category it refers to. In the current embodiment of the invention, Variable Meta Information is the user input text title of the Variable.

In another embodiment of the invention, Variable Meta Information can include, but is not limited to, at least one of either creation date, creation user, a category or subcategory from which the variable was selected for comparison, or any information used for the purposes of describing the comparison category. In yet other embodiments, Variable Meta information may include information linking variables to other variables.

F. Definition of Annotation.

Annotations herein are information used for the purpose of segregation of unrelated and linking amongst a group comprising at least one of either: a unique digital identifier for elements linked to the Annotation (Annotation ID), descriptive information about their file and comparison category(s) of Reference (File ID, Variable ID combination) descriptive information about annotation content (Annotation Meta-Information), and descriptive information about their location within a File (Annotation Location).

Annotation ID's herein are information used for the purposes of unique identification of an Annotation as well as segregation of unrelated and linking amongst related: File ID of the annotation source, Annotation Meta Information, Annotation Location, and one or more input Variable ID's. In the current embodiment of the invention, an Annotation ID's is a unique numeral assigned to a group comprising: input Annotation Meta-Information, input Annotation Location, one or more Variable ID's the annotation is referring to, and File ID of the annotation source. It will be understood by those skilled in the art that the format for the Annotation ID may also include alpha or alpha-numeric information as long as the Annotation ID is unique within the present embodiment's Annotation ID configuration.

Annotation Meta Information herein is information used for the purpose of containing the content of input resource annotations.

In the current embodiment of the invention, Annotation Meta Information is the user input text of an annotation, including but not limited to, a user's subjective or objective observation about the given File.

In another embodiment of the present invention, Annotation Meta Information would comprise any information sufficient for the purpose of describing the Annotation, including but not limited to, a subset of user selected multimedia (text, video, audio, or graphic) or other forms of information which could be extracted from the File.

In another embodiment of the present invention, Annotation Meta Information would comprise a container portion of the user's selected multimedia. For example, but without limitation, Annotation Meta Information may comprise the paragraph from which the user selected text, the container HTML element of an HTML document, or a clip of audio beyond which the Annotation was selected.

Annotation Location herein is information used for the purpose of describing the location that the input Annotation Meta Information refers to. In the current embodiment of the invention, it is the page number of reference where the Annotation was input by the User for a text document. In another embodiment of the invention, Annotation Location could comprise any information describing the location which is referred to by the Annotation, including but not limited to, a specific set of Cartesian coordinates describing the precise visual location of the selected Annotation input location as well as a specific time or offset time from a video or audio clip's beginning or end. It could be input by the user or generated by any other means.

G. Definition of Resource Review.

Resource Review as used herein is information used for the purpose of segregating unrelated and linking amongst a related group comprising at least one of either: a unique digital identifier for elements linked to a Resource Review (Resource Review ID), Resource Review Meta Information, one or more Variables, one or more Files, and one or more Annotations.

Resource Review ID herein is information used for the purposes of unique identification of a Resource Review as well as segregation of and linking amongst its linked Variables, Files, and Annotations. In the current embodiment of the invention, Resource Review ID is a unique numeral assigned to a group comprising at least one of either: linked Resource Review Meta Information, one or more linked Variables, one or more linked Files, and one or more linked Annotations.

It will be understood by those skilled in the art that the format for the Resource Review ID may also include alpha or alpha-numeric information as long as the Resource Review ID is unique within the present embodiment's Resource Review's ID configuration.

Resource Review Meta Information herein is information used for the purpose of describing a Resource Review. In the current embodiment of the invention, this comprises at least the user input text title of the Resource Review.

In another embodiment of the invention, Resource Review Meta Information could include, but is not limited to title, author(s), general description, methods for conducting the review, and/or creation date or any information sufficient for the purpose of describing a Resource Review.

H. Methods for Interacting with a User's Files and Variables.

Methods for the purpose of interaction with a single user's Files and Variables comprise at least one of either: View Library, Add File to Library, View File, Edit File Meta Information, Remove File from Library, Add Variable to Library, View Variable, Edit Variable Meta Information, and Remove Variable from Library.

View Library herein is a method comprising the general purposes of: retrieval of all Files and Variables linked to the User ID, display of their linked Meta Information, and display of options to access further methods for interaction.

1. Methods for Interacting with Files in a User's Library

Add File to Library herein is a method comprising the general purposes of: display of input method for a Digital Representation of a File, display of ability for user to confirm or deny input, creation and storage of a File ID, linkage of File ID to User ID, conversion of the Digital Representation to a Visual Representation of a File, extraction of File Meta Information, storage of Digital Representation of File, Visual Representation of File and File Meta Information and their linkages to File ID.

View File is a method comprising the general purposes of: retrieval and display of File Meta Information, retrieval and display of Visual Representation of File, and display of options to access further methods for interaction with the requested File.

Edit File Meta Information herein is a method comprising the general purposes of: retrieval and display of File Meta Information in editable (input) format, display of input method for user to confirm/deny edit, and storage of updated File Meta Information.

Remove File From Library herein is a method comprising the general purposes of: display of input method for user to confirm/deny removal, removal of linked components of a File, and removal of all linkage to and from the selected File's File ID sufficient to limit program and user access to appropriate Files.

2. Methods for Interacting with Variables in a User's Library

Add Variable to Library is a method comprising the general purposes of: display of input method for Variable Meta Information, display of input method for confirmation/denial of addition, creation and storage of a Variable ID, storage of Variable Meta-Information, as well as linkage of User ID and Variable Meta Information to Variable ID.

View Variable is a method comprising the general purposes of retrieval and display of the requested Variable's Variable Meta Information, display of options to access further methods for interaction with a Variable.

Edit Variable Meta Information is a method comprising the general purposes of: retrieval and display of Variable Meta information as user editable input, display of input method for confirmation/denial of edit, and storage of updated Variable Meta-Information.

Remove Variable is a method comprising the general purposes of display of input for confirmation/denial of removal and removal of all linkages to and from the Variable's Variable ID sufficient to limit program and user access to appropriate Variables.

I. Methods of a Group Comprising Resource Reviews.

Methods for the purpose of interaction with the group including Resource Reviews of a given User comprise at least one of either: View All Resource Reviews, Create New Resource Review, View Resource Review, Edit Resource Review and Remove Resource Review.

View All Resource Reviews is a method comprising the general purposes of: retrieval of all Single Resource Reviews linked to a given User ID, display of their linked Meta Information, and display of options to access further methods for interaction for each Retrieved Single Resource Review.

Create New Resource Review is a method comprising the general purposes of: display of input for Resource Review Meta Information, display of input to confirm or deny creation of a new Resource Review, creation and storage of a new Resource Review ID, storage of input Resource Review Meta Information, creation and storage of a linkage among the Resource Review Meta Information and the Resource Review ID, creation and storage of a linkage among the User ID and Resource Review ID.

View Single Resource Review is a method comprising the general purposes of: retrieval and display of requested Resource Review's Meta Information, retrieval of Variables, Files, and Annotations linked to the given Single Resource Review, display of Variable and File Meta Information along separate axes, calculation of display location of retrieved annotations within Variable x File cross reference, display of Annotation Meta Information in calculated location, display of Annotation Location in calculated location, display of options to further access methods of interaction.

Edit Resource Review Meta Information is a method comprising the general purposes of: retrieval of Resource Review Meta Information of a given Single Resource Review, display of input to confirm or deny edit, display of editable input of Resource Review Meta Information, storage of updated Resource Review Meta Information.

Remove Resource Review is a method comprising the general purposes of: display of input to confirm/deny removal of Resource Review, removal of linked components of a Single Resource Review, and of all linkages to and from the given Single Resource Review's Resource Review ID sufficient for the purposes of limiting program access to appropriate Resource Reviews and their linked elements.

J. Methods of Interacting with a File in a Resource Review.

Available methods for adding File(s) to a Resource Review comprise at least one of either: Add File from Outside the Program and Add Existing File to Resource Review.

Add File From Outside the Program (Add New File to Resource Review) is a method comprising the general purposes of: display of ability to confirm/deny addition of File, display of input method for a Digital Representation of a File, display of ability for user to confirm or deny input, creation and storage of a File ID, linkage of File ID to User ID, conversion of the Digital Representation to a Visual Representation of a File, extraction of File Meta Information, storage of Digital Representation of File, Visual Representation of File and File Meta Information and their linkage to File ID and storage of linkage between File ID being added and the Resource Review ID. Its purpose is parallel to that of adding a file to the library with the addition of their linkage to the Resource Review.

Add Existing File to Resource Review is a method within the Add File to Resource Review Method comprising the general purposes of: display of ability to confirm/deny addition of File, retrieval and display of File Meta Information of Files linked to the User ID, display of ability to select one or more files to add to the Resource Review, and storage of linkage between File ID(s) being added and the Resource Review ID.

In the current embodiment of the invention, there is no implemented method to limit the addition of a given File to a Resource Review which is already linked to the Resource Review. That is, Users can add the same File already linked to their User ID to the same Resource Review multiple times. In another embodiment of the invention, a method could be used to prevent the User from adding the same file multiple times, or to alert them to the fact that the given File is already linked to the Resource Review.

In the current embodiment of the invention, Files are isolated to the invention. That is, there is no implemented method to retrieve files from an external source to add to a User's Library or Resource Review. It will be understood to those skilled in the art that, in an alternative embodiment, the User's Library could be linked to an external source of Files such that Files could be searched for and/or added to the User's Library or a Resource Review through an external mechanism without compromising the essential functions of the invention. For example but without limitation, such an embodiment could provide an interface to query, for example, the PubMed Search Engine and download files from it to the invention.

In the current embodiment, Editing File Meta Information happens within a User's Library and its changes affect the File in the Resource Review as well. As such, it is not a separately available method through the Resource Review. In another embodiment of the invention it could be included as a separate method here.

Remove File from Resource Review is a method comprising the general purposes of: display of input method for user to confirm/deny removal, and removal of all linkage to and from the selected File's File ID sufficient for the purposes of limiting program access to appropriate Files.

K. Methods of interacting with a Variable in a Single Resource Review.

In an embodiment of the present invention, a method to Add a Variable to a Resource Review generally comprise: Add New Variable to Resource Review, and Adding Existing Variable to Resource Review.

Add New Variable to Resource Review is a method comprising the general purposes of: display of ability to confirm/deny Variable addition, display of input for Variable Meta Information, creation and storage of Variable ID, Variable Meta Information storage and linkage to Variable ID, storage of linkage between Variable ID and User ID, storage of linkage of Variable ID and Resource Review ID.

Add Existing Variable to Resource Review is a method comprising the general purposes of: retrieval of Variables linked to User ID, display of ability to confirm/deny Variable addition, display of input for addition of one or more retrieved Variables, storage of linkage of Variable ID(s) and Resource Review ID.

In the current embodiment of the invention, there is no implemented method to limit the addition of a given Variable to a Resource Review which is already linked to the Resource Review. That is, Users can add the same Variable already linked to their User ID to the same Resource Review multiple times. In another embodiment of the invention, a method could be used to prevent the User from adding the same Variable multiple times, or to alert them to the fact that the given Variable is already linked to the Resource Review.

In the current embodiment of the invention, Variables are isolated to the invention. That is, there is no implemented method to retrieve variables from an external source to add to a User's Library or Resource Review. It will be understood to those skilled in the art that the User's Library could be linked to an external source of Variables such that Variables could be searched for and/or added to the User's Library or a Resource Review through an external mechanism without compromising the essential functions of the invention. For example but not limitation, in such an embodiment, the invention could query an external data source such as Wikipedia for headings and provide the heading as the Variable.

Edit Variable Meta Information is a method comprising the general purposes of: display of input to confirm/deny edit, retrieval of Variable Meta Information of a given Variable, display of editable input of retrieved Variable Meta Information, and storage of updated Variable Meta Information.

Remove Variable from Resource Review is a method comprising the general purposes of: display of input method for user to confirm/deny removal, removal of Variable Meta information, retrieval of linked elements to given Variable ID and Resource Review ID, and removal of all linkage to and from the selected Variable's Variable ID sufficient to limit program access to appropriate Variables.

L. Methods of Interacting with an Annotation in a Resource Review.

Annotate File is a method comprising the general purposes of: retrieval and display of Visual Representation of File, retrieval and display of File Meta Information, retrieval of Annotation ID's of a given File, retrieval of Variable Meta Information, Annotation Location, and Annotation Meta Information of retrieved Annotation ID's, calculation of location of Annotation Location within Visual Representation of File, display of Annotation Meta Information and its Variable Meta Information in a region corresponding to Annotation Location, and display of options to access further methods for interaction with the File. Its purpose is parallel to that of the View File Method with the additional ability to view Annotations, add them to the file and interact with the annotations.

View Annotation is a method comprising the general purposes of: retrieval of File Meta Information and Visual Representation of File, retrieval of annotations linked to a File, retrieval of variables of the retrieved annotations, calculation of the display location of the retrieved variables and annotations using the annotation Locations, display of File Meta Information, Visual Representation of File, as well as Annotation Meta Information and location in calculated locations, directing movement of the display to the calculated location of the selected Annotation, and display of options for further interaction with the File and its Annotations.

Edit Annotation Meta Information is a method comprising the general purposes of: display of input to confirm/deny edit, retrieval of Annotation Meta Information, Annotation Location, Variable(s) linked to annotation, and Variables linked to the Resource Review of a given Annotation, display as editable input of retrieved Annotation Meta Information, Annotation Location, and Variable(s), and storage of updated information.

Remove Annotation is a method comprising the general purposes of: display of input for user to confirm/deny removal, removal of Annotation Meta Information, removal of Annotation Location and removal of all linkage to and from the given Annotation's Annotation ID sufficient for the purposes of limiting program access to appropriate annotations.

Add Annotation to File is a method comprising the general purposes of: calculation of Annotation Location within Visual Representation of File, display of input to confirm/deny Annotation addition, retrieval and display of Variable Meta Information of Variables linked to the given Resource Review, display of input for user to select one or more Variables, display of input for Annotation Meta Information, creation and storage of an Annotation ID, storage and linkage of Annotation Location to Annotation ID, Linkage of Annotation ID to Resource Review ID and Annotation Meta Information, and linkage of Annotation ID to the File and Variable(s) of reference (File ID, Variable ID) Combination.

In the current embodiment of the invention, the Add Annotation to File method is only available from within the Annotate File method. In another embodiment, the embodiment would allow the User to add an Annotation to a File from within the View Single Resource Review Method. In such an embodiment, the embodiment would permit the invention to achieve the purposes of the Add Annotation to File method with some other means of establishing the Location. One such embodiment would assign the Annotation Location to a constant, such as Page 1, or it could exclude this information altogether.

### II. Program Flow.

A. User Access Control.

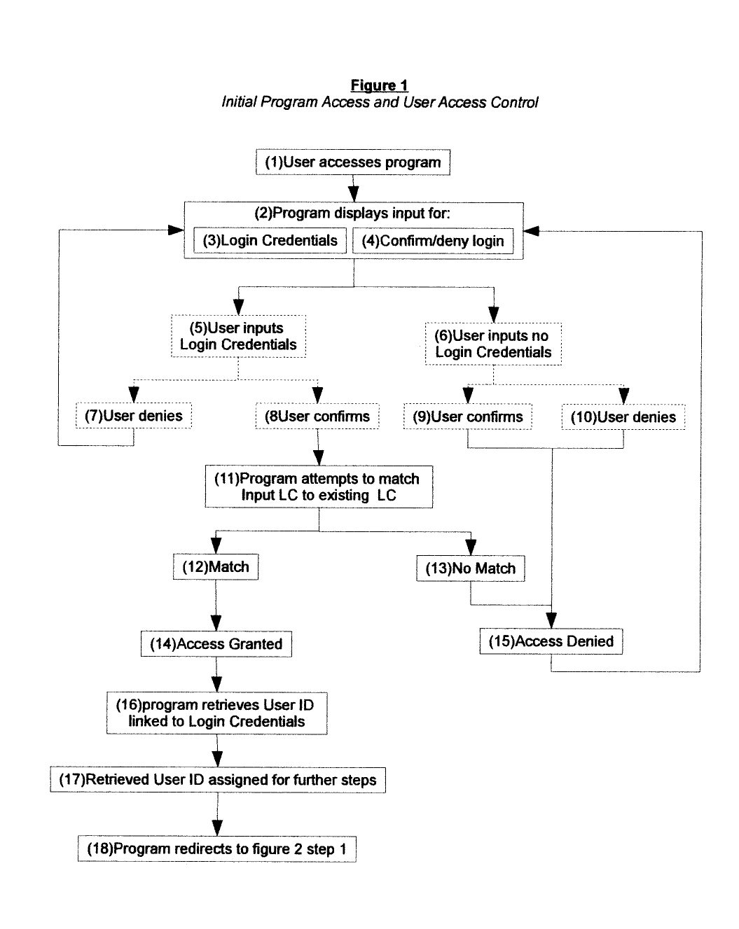

Now referring to the drawings, FIG. 1 depicts the flow diagram of user access control. Initially, as the user accesses the program 1, the invention displays input 2 for Login Credentials 3 and to confirm or deny the submission of the login credentials 4.

If the user inputs no Login Credentials 6 and confirms 9 or denies 10 submission of the credentials, or if the user inputs their Login Credentials 5 and denies submission 7, the program denies access 15 and again displays input for the login credentials 2.

If the user inputs their Login Credentials 5 and confirms submission 8, the program then attempts to match the input Login Credentials to an existing set of stored Login Credentials 11.

If there is no match between the input Login Credentials and an existing set of Login Credentials stored by the system 13, the system denies access to the individual user's information 15. In the current embodiment of the invention, the invention then again displays the ability to input Login Credentials 2. In another embodiment of the invention, there may be any number of security or user access control features added to restrict access or otherwise enhance the security and robustness of the login process. In all embodiments, the general purpose is to restrict user access to program resources to those with appropriate credentials. In other embodiments, this step could be left out and the user authentication process could be handled externally. In these embodiments, the initial step would be similar to 16, and the User ID could be considered a preset-constant.

If there is a match between the input Login Credentials and an existing set of Login Credentials stored by the system 12, the system proceeds with access to the individual user's information 14. The User ID associated with the set of matching, input Login Credentials is assigned for further reference by the program as the User ID 17. The purpose of this assignment is to segregate multiple users' data and to retrieve data from only the appropriate user.

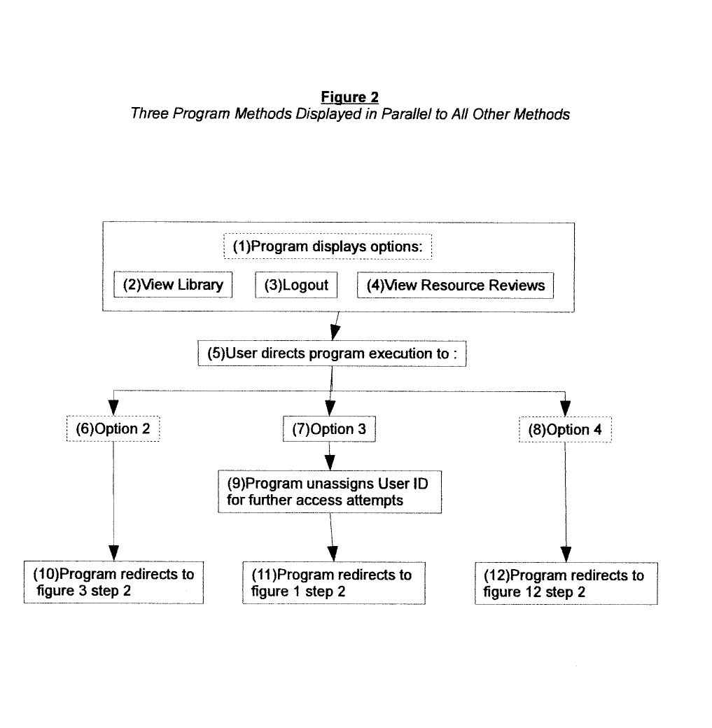

In the current embodiment of the program, after assignment of the retrieved User ID as the User ID, the program then directs execution to FIG. 2. In another embodiment of the program, the program could direct execution to any step sufficient for further interaction with the program.

### III. General Divisions of the Program.

Referring now to FIG. 2, the invention initially displays three options to the user 1, View the Library 2, View Resource Reviews 4, or Log-out 3.

The purpose of the former two options is to allow user interaction with the two primary divisions of the invention's functionality, namely interactions with all the User's Files and Variables or Interaction with a User's Files, Variables and Annotations linked to a Resource Review.

The purpose of the last option is to restrict further access to the User's stored information. In the current embodiment of the program, this is done by unassigning the User ID for further access by the program.

In the current embodiment, these three options are constantly presented in parallel with other options as base starting points for further methods and processes. In another embodiment, any method of navigation within the invention's various methods is sufficient as long as it meets the purposes described herein.

IV. Methods for Interacting with a User's Files and Variables.

A. Initial Selection of the Library Option.

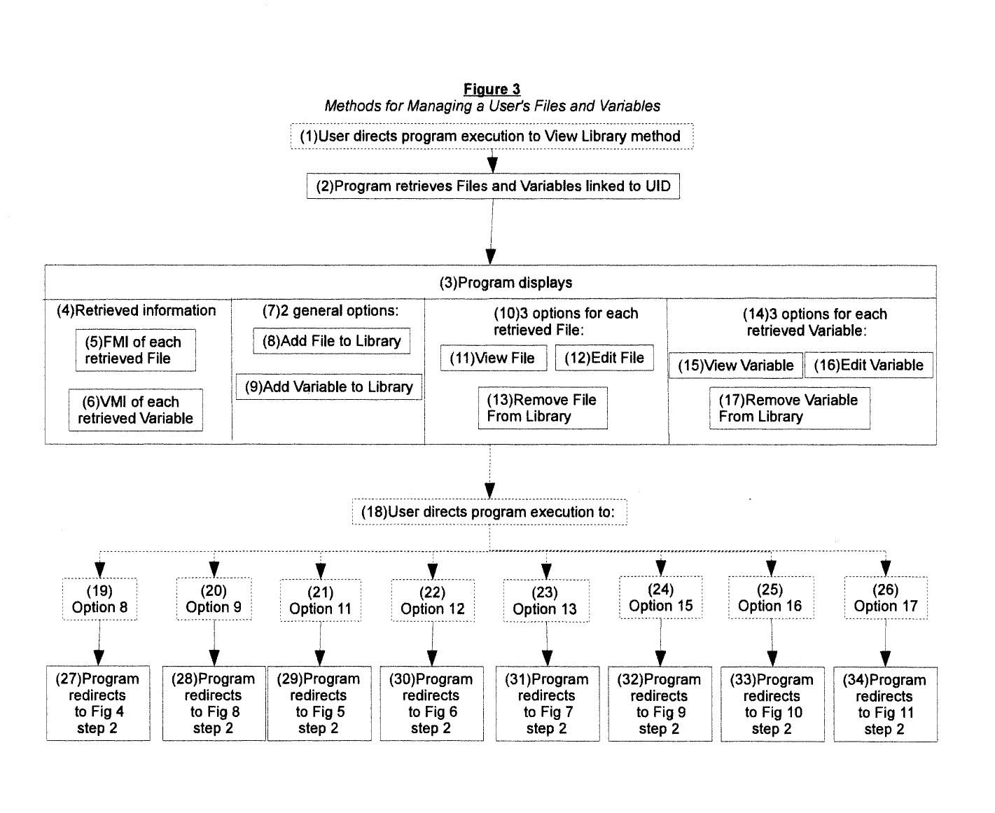

Referring now to FIG. 3, if the user directs program execution to the View Library option 1, the program attempts to retrieve Files and Variables linked to the User ID 2. The purpose of this method is to retrieve only stored Files and Variables that the User should have access to.

If there is one or more File ID's linked to the User ID, the invention references the File ID to retrieve associated File Meta Information of each File ID linked to the User ID. The purpose of this step is to retrieve File Meta Information of all Files previously input to the program by a User.

In the current embodiment of the invention, there is no implemented method for limiting the display of files within the Library. In another embodiment, there could be a method for creation and grouping of Files within collections in the Library. In such an embodiment, the user could organize files into groups with the library and add entire groups of files to a literature review.

The program then displays File Meta Information for each retrieved File ID 5 as well as options to View the File 11, Edit the File's Meta Information 12 and Remove the File from the Library 13. The purpose of this step is to allow for further interaction 10-13 with the retrieved Files.

If there is one or more Variable ID's linked to the User ID, the invention references the Variable ID to retrieve associated Variable Meta Information of each Variable ID linked to the User ID. The purpose of this step is to retrieve Variable Meta Information of all Variables previously input to the program by a User.

In the current embodiment of the invention, there is no implemented method for limiting the display of Variables within the Library. In another embodiment, there could be a method for creation and grouping of Variables within collections in the Library. In such an embodiment, the user could organize Variables into groups with the library and add entire groups of Variables to a literature review.

The program then displays Variable Meta Information for each retrieved Variable ID 6 as well as options to View the Variable 15, Edit the Variable's Meta Information 16 and Remove the Variable from the Library 17. The purpose of this step is to allow for further interaction 14-17 with the retrieved Files.

The program also displays 3 two general options 7: the option to add a file to the library 8 and the option to add a variable to the library 9. The purpose of these options is to allow the user to allow User addition of a new File or Variable within the program.

In the current embodiment of the invention, there is not a method defined to retrieve the Digital Representations of Files input to the invention. In another embodiment of the invention, this could be implemented in any method sufficient to for the user to select a file and retrieve the Digital Representation for the purpose of allowing the user to retrieve the Digital Representation of the File from a different storage medium (e.g., a separate hard drive or another portable storage device.)

B. Adding a File to the Library

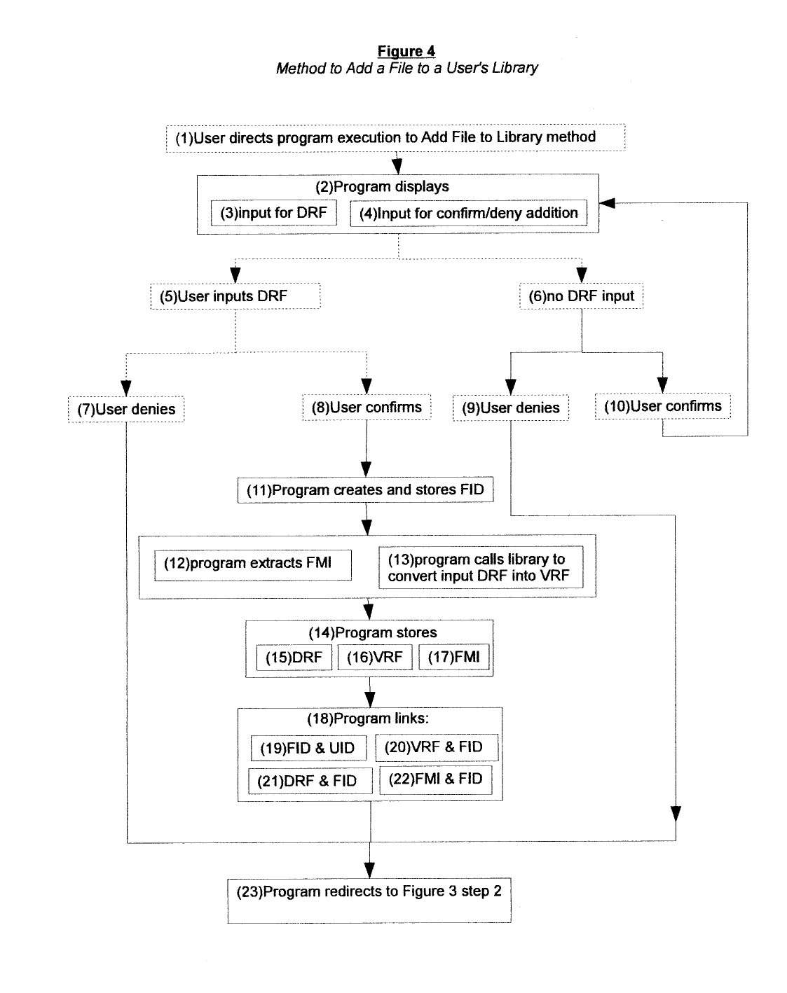

Referring now to FIG. 4, if the user directs program execution to Add a File to the Library 1, the program displays 2 the ability for the user to input a Digital Representation of a File to the program 3 and to accept or deny addition 4. The user then inputs a Digital Representation of a File 5 through any method compatible with the invention, including but not limited to, clicking on a file, typing in a file name, local or networked computer path, or reference URL. The purpose of this step is to allow for input of a digital representation of a file to the invention.

If the user chooses to accept the addition 8, the program is then able to manipulate the input Digital Representation of the File.

The program creates and stores a unique File ID 11 for the purposes of linkage and retrieval of a File's Meta Information, Visual Representation, and Digital Representation for a single User.

In the current embodiment of the invention, the program extracts File Meta Information from the File 12. In another embodiment, Meta information generated for a file 12 could be input manually instead.

The invention also calls an external library to convert the Digital Representation of the File into a compatible form, herein named the Visual Representation of the File, for the program 13. The overall purpose of this step is to allow the program to display a Visual Representation of the File to the User from an input Digital Representation of the File.

The program stores the File's Digital Representation 15, Visual Representation 16, and Meta Information 17.

The invention creates and stores a linkage between the File ID and User ID 19 for the purpose of retrieval of input Files and their linkages by the User.

The invention also creates and stores a linkage between the File's ID, and its Digital Representation 21, Visual Representation 20, and Meta Information 22 for the purposes of retrieving them through reference to File ID.

In the current embodiment of the invention, the invention then directs program execution to FIG. 3. In another embodiment, the invention could redirect to any point within the invention with the end result fulfilling the purposes described above and allowing the user to further interact with the invention.

If at any time after choosing to add a file to the library 1, the user decides not to add the file to the invention, they can deny the addition 7 or 9. In the current embodiment of the program, the program then directs execution to FIG. 3. In another embodiment of the program, the program could direct execution to any step sufficient for further interaction with the program.

If the user does not input a Digital Representation of the File 6 but confirms submission 10, the program directs execution to FIG. 4 and again displays input for the File and confirmation/denial of submission. In another embodiment of the program, the program could direct execution to any step sufficient for further interaction with the program.

C. Viewing a File and Methods Associated with Viewing A File in the Library.

Referring again to FIG. 3, another way to interact with retrieved files is to view the Visual Representation of the File referenced by the retrieved File ID 11. After the invention displays the option to view a Visual Representation of the File 11, users may direct program execution to that option 21.

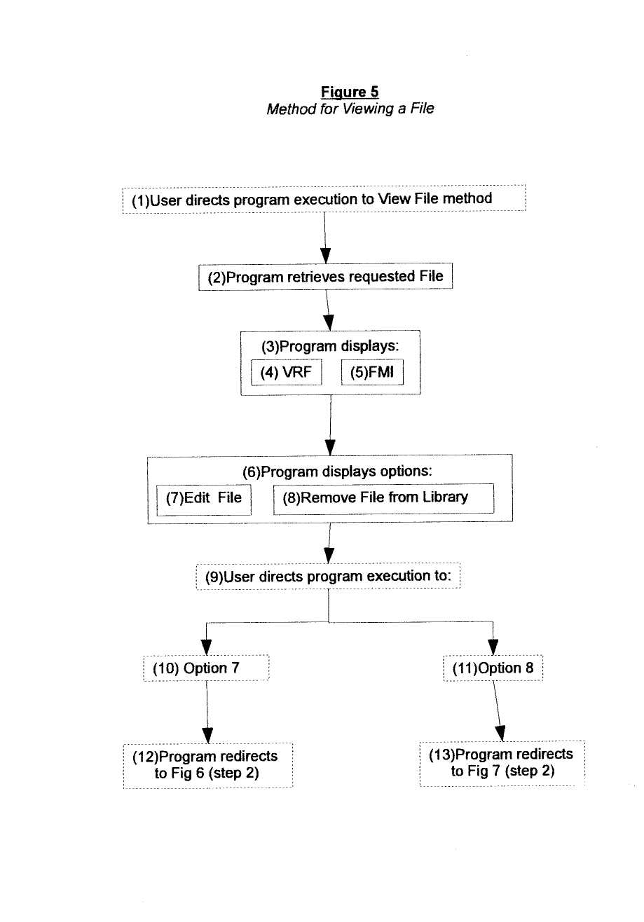

Referring now to FIG. 5, if the user directs program execution to view a Visual Representation of the File 1, the program then retrieves the Visual Representation of the File ID 2 and File Meta Information referenced by the requested File ID 2.

The program then displays 5 the retrieved Visual Representation 4 and File Meta Information 5.

The program then displays the options to edit File Meta Information 7, or remove the File from the user's Library 8.

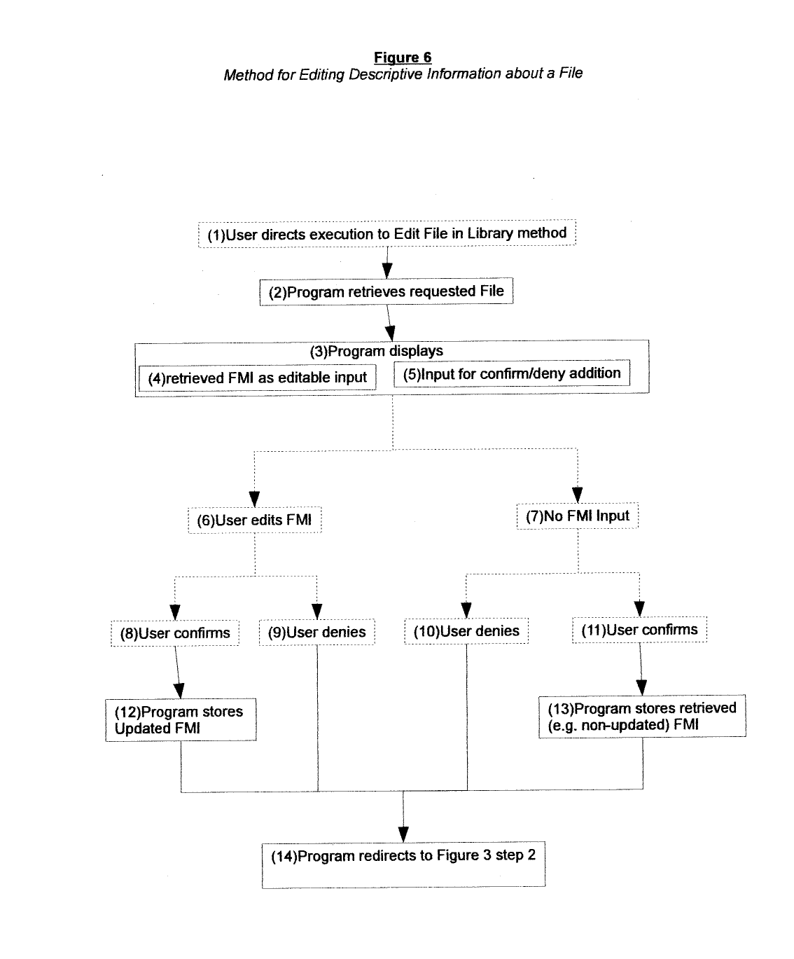

If the user directs program execution to Edit the File Meta Information 10, the program directs execution to FIG. 6.

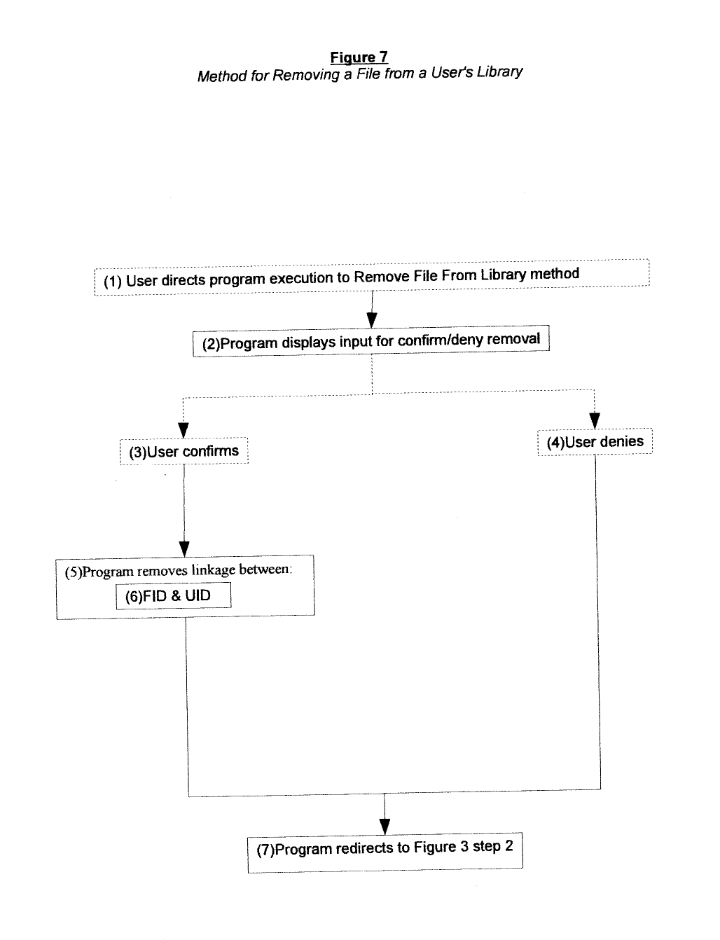

If the user directs program execution to Remove the File from the Library 11, the program directs execution to FIG. 7.

D. Editing File Meta Information in the Library

Referring again to FIG. 3, another way to interact with retrieved files is to edit their File Meta Information retrieved in 2 and displayed in 5. After the invention displays the option to edit File Meta Information of a given file 12, users may direct program execution to that option 22.

Referring now to FIG. 6, if the user directs program execution to edit File Meta Information 1, the invention retrieves stored File Meta Information by referencing the requested File ID 2. The invention then displays 3 an editable input version of the retrieved File Meta Information 4 and the ability to confirm or deny the edit 5. The user can then edit the input 6, leave it the same 7, and confirm 8 or 11 or deny 9 or 10 the edit.

The user may choose to deny the edit with 9 or without 10 editing the File Meta Information. If the user chooses to deny the edit 9 or 10, the program directs execution 14 to FIG. 3 step 2.

If the user edits the File Meta Information 6 and accepts the edit 8, the invention stores the updated File Meta Information 12. The purpose of this step is to change the existing File Meta Information. In another embodiment of the invention, the program may check for and store only the differences between the original information and the updated information such that the new information is displayed and a log of changes is kept.

If the user does not edit the File Meta Information 7 and accepts the edit 11, the program re-stores the original, non-updated File Meta Information 13. The purpose of this step is to leave the existing meta-information intact.

Following this storage per 12 or 13, in the current embodiment of the invention, the invention then redirects execution to retrieving the File's and Variables linked to the User ID 2 (FIG. 3). In another embodiment, the invention could redirect to any point within the invention with the end result fulfilling the purposes described above and allowing the user to further interact with the invention.

E. Removing a File from the Library

Referring again to FIG. 3, another way to interact with retrieved files is to remove them from the invention. After the invention displays the option to remove a file from the library 13, users may direct program execution to that option 23.

Referring now to FIG. 7, if a user directs program execution to the remove file from library method 1, the program displays input for confirmation and denial of removal 2.

If the user confirms removal of the file 3 the program removes the linkage between the File ID and User ID 6. The program then directs execution to FIG. 3.

The purposes of this step is to prevent retrieval of the File by the program's methods including but not limited to the View Library Method and View Resource Review Method as well as retrieval of annotations linked to the File in a specific Resource Review.

If the user denies removal of the file 4, the program directs execution to FIG. 3. The purposes of this step is to continue allowing retrieval of the File by the program's methods including but not limited to the View Library Method and View Resource Review Method as well as retrieval of annotations linked to the File in a specific Resource Review.

In the current embodiment of the invention, the invention then goes back to retrieving the File's and Variables linked to the User ID 2 (FIG. 3). In another embodiment, the invention could redirect to any point within the invention with the end result fulfilling the purposes described above and allowing the user to further interact with the invention.

F. Adding a Variable to the Library

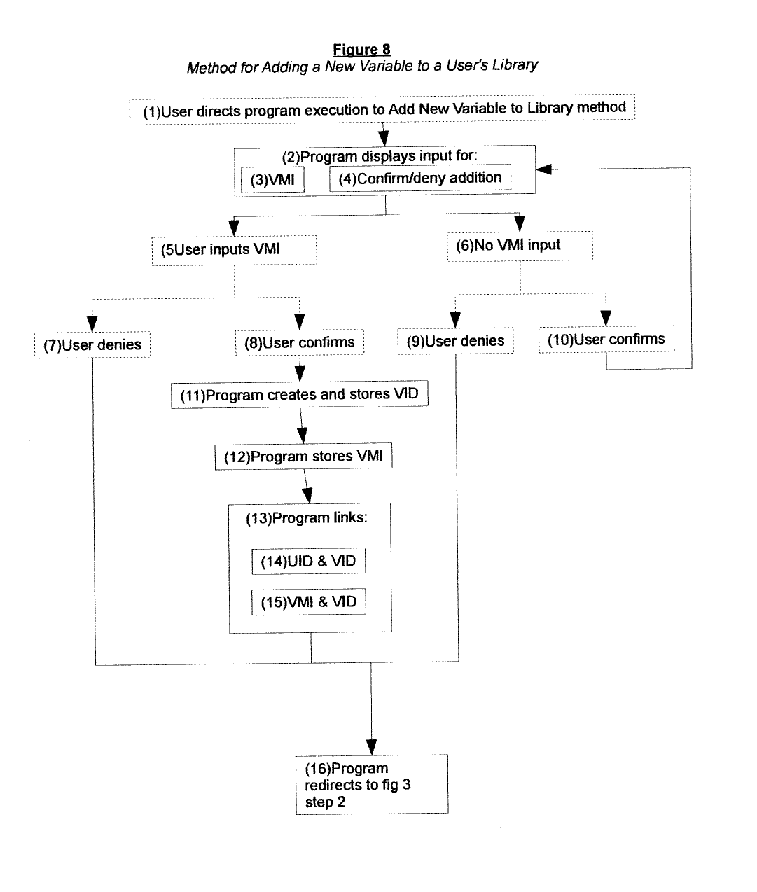

Referring again to FIG. 3, if the user directs program execution to add a Variable to the library 20, the program directs execution 28 to that method as described in FIG. 8.

Referring now to FIG. 8, if the user directs program execution to Add New Variable to library method 1, the program displays 2 the ability for the user to input Variable Meta Information 3 and to accept or deny addition 4.

The user then inputs Variable Meta Information 5 through any method compatible with the invention, including but not limited to, clicking on a file, typing in Variable Meta Information name, a local or networked computer path, or reference URL. The purpose of this step is to allow for input of Variable Meta Information to the invention.

If the user chooses to accept the addition 8, the program creates and stores a unique Variable ID 11 for the purposes of linkage and retrieval of a Variable's Meta Information to a Variable ID and User ID.

The program then stores the Variable's Meta Information 12.

The program creates and stores a linkage between the Variable ID and User ID 14 for the purpose of retrieval of input Variables and their linkages by the User.

The invention also creates and stores a linkage between the Variable's ID, and its Meta Information 15 for the purposes of retrieving it through reference to Variable ID.

In the current embodiment of the invention, the invention then directs program execution 16 to FIG. 3. In another embodiment, the invention could redirect to any point within the invention with the end result fulfilling the purposes described above and allowing the user to further interact with the invention.

If at any time after choosing to add a Variable to the library 1 (FIG. 8), the user decides not to add the Variable to the invention, they can deny the addition 7 or 9. In the current embodiment of the program, the program then directs execution to FIG. 3. In another embodiment of the program, the program could direct execution to any step sufficient for further interaction with the program.

If the user does not input Meta Information for the Variable 6 (FIG. 8) but confirms submission 10, the program directs execution to FIG. 8 and again displays input for the Variable's Meta Information and confirmation/denial of submission. In another embodiment of the program, the program could direct execution to any step sufficient for further interaction with the program.

G. Viewing a Variable and Methods Associated with Viewing a Variable in the Library.

Referring again to FIG. 3, another way to interact with retrieved Variables is to view the Meta Information of the Variable referenced by the retrieved Variable ID 15. After the invention displays the option to view Meta Information of the Variable 15, users may direct program execution to that option 24.

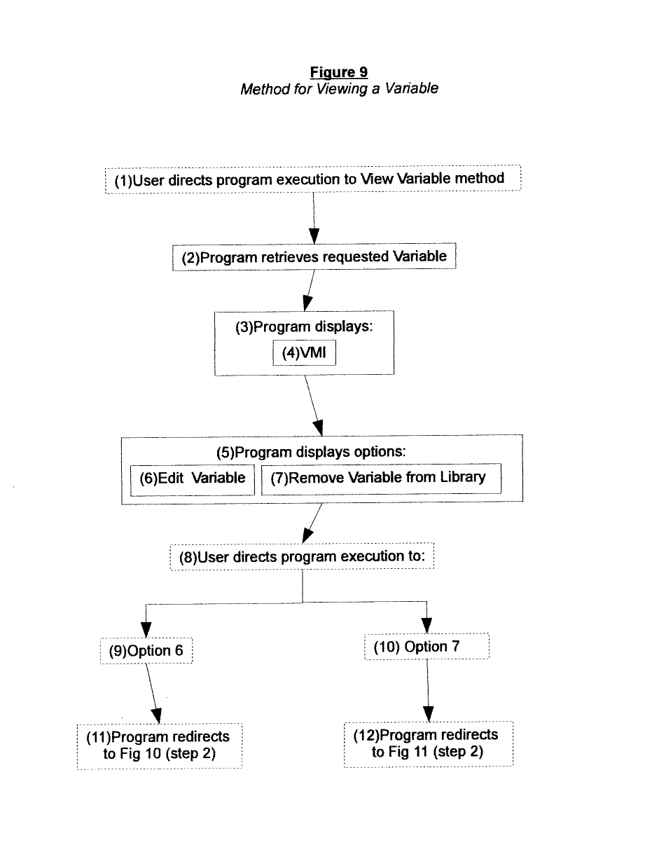

Referring now to FIG. 9, if the user directs program execution to view Meta Information of the Variable 1, the program then retrieves Meta Information of the Variable 2 and displays it 4.

The program also displays options 5 to edit Variable Meta Information 6, or remove the Variable from the user's Library 7.

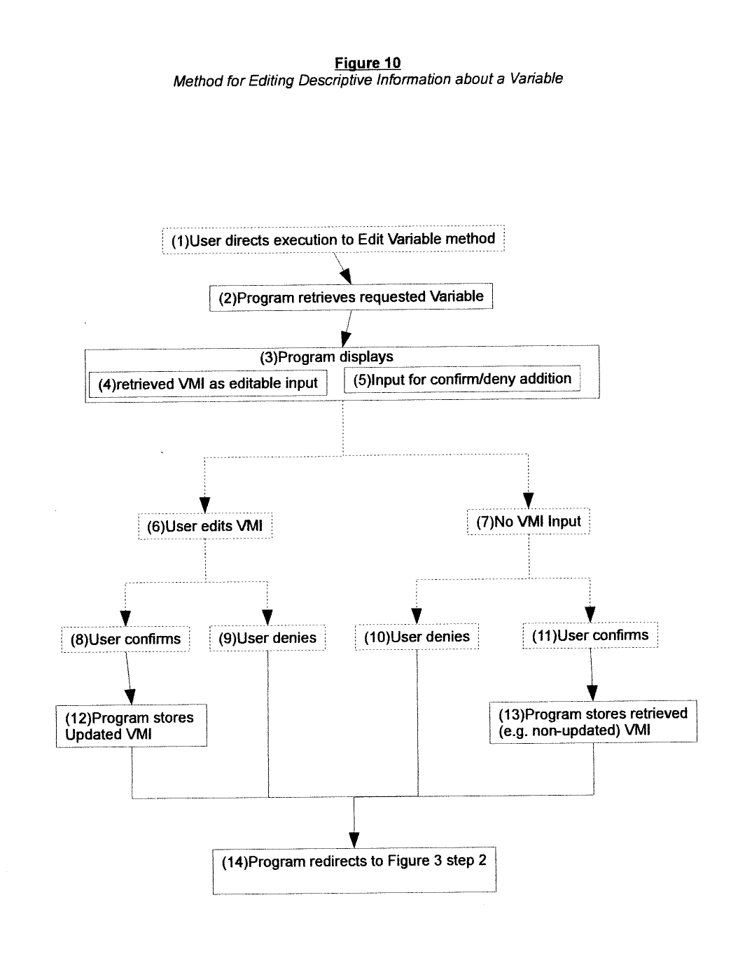

If the user directs program execution to Edit the Variable Meta Information 9, the program directs execution to FIG. 10.

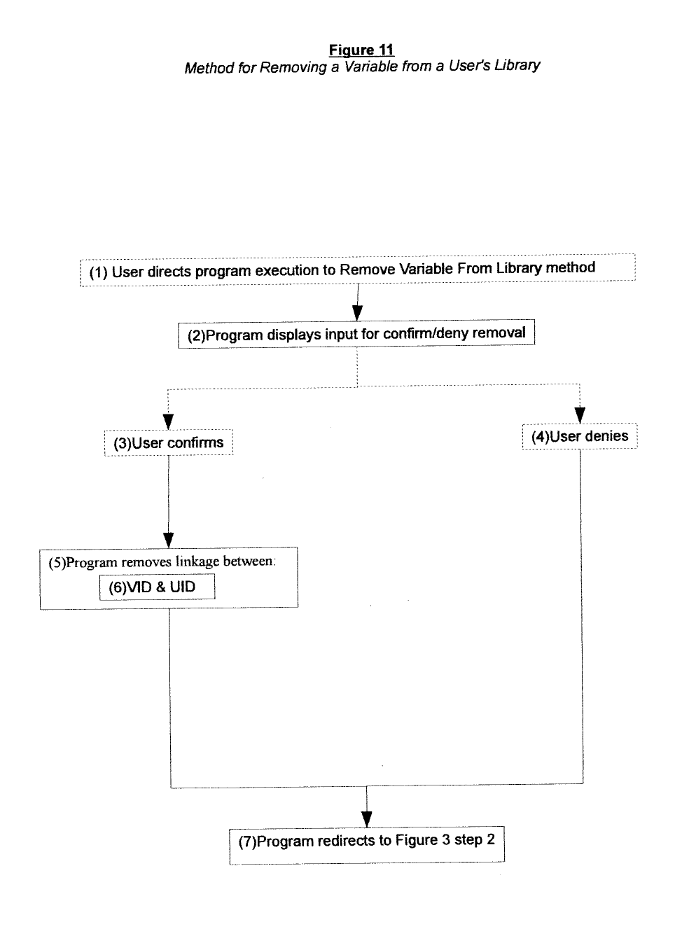

If the user directs program execution to Remove the Variable from the Library 10, the program directs execution to FIG. 11.

H. Editing Variable Meta Information in the Library

Referring again to FIG. 3, another way to interact with retrieved Variables is to edit their Variable Meta Information retrieved in 2 and displayed in 6. After the invention displays the option to edit Meta Information of a given Variable 16, users may direct program execution to that option 25.

Referring now to FIG. 10, if the user directs program execution to edit Variable Meta-Information 1, the invention retrieves stored Variable Meta Information by referencing the requested Variable ID 2. The invention then displays 3 an editable input version of the retrieved Variable Meta Information 4 and the ability to confirm or deny the edit 5. The user can then edit the input 6, leave it the same 7, and confirm 8 or 11 or deny 9 or 10 the edit.

The user may choose to deny the edit with 9 or without 10 editing the Variable Meta Information. If the user chooses to deny the edit 9 or 10, the program directs execution 14 to FIG. 3 step 2.

If the user edits the Variable Meta Information 6 and accepts the edit 8, the invention stores the updated Variable Meta Information 12. The purpose of this step is to change the existing Variable Meta Information. In another embodiment of the invention, the program may check for and store only the differences between the original information and the updated information such that the new information is displayed in a log of changes is kept.

If the user does not edit the Variable Meta Information 7 and accepts the edit 11, the program re-stores the original, non-updated Variable Meta Information 13. The purpose of this step is to leave the existing meta-information intact.

Following this storage 12 or 13, in the current embodiment of the invention, the invention then redirects execution to retrieving the File's and Variables linked to the User ID 2 (FIG. 3). In another embodiment, the invention could redirect to any point within the invention with the end result fulfilling the purposes described above and allowing the user to further interact with the invention.

I. Removing a Variable from the Library.

Referring again to FIG. 3, another way to interact with retrieved Variables is to remove them from the program. After the invention displays the option to remove a Variable from the library 17, users may direct program execution to that option 26.

Now referring to FIG. 11, if a user directs program execution to the Remove Variable from Library method 1, the program displays input for confirmation and denial of removal 2.

If the user confirms removal of the file 3 the program removes the linkage between the Variable ID and User ID 6. The program then directs execution to FIG. 3.

The purposes of this step is to prevent retrieval of the Variable by the program's methods including but not limited to the View Library Method and View Resource Review Method as well as retrieval of annotations linked to the Variable in a specific Resource Review.

If the user denies removal of the variable 4 the program directs execution to FIG. 3. The purposes of this step is to continue allowing retrieval of the Variable by the program's methods including but not limited to the View Library Method and View Resource Review Method as well as retrieval of annotations linked to the File in a specific literature review.

In the current embodiment of the invention, the invention then goes back to retrieving the Files and Variables linked to the User ID 2. In another embodiment, the invention could redirect to any point within the invention with the end result fulfilling the purposes described above and allowing the user to further interact with the invention.

V. Methods for Interacting with a Resource Review.

Referring again to FIG. 2, another main division of the program is the Resource Review Methods. After the program displays the option to View Resource Reviews 4, Users may choose to direct program execution to that option 8. A. Initial Selection of the Resource Review Option.

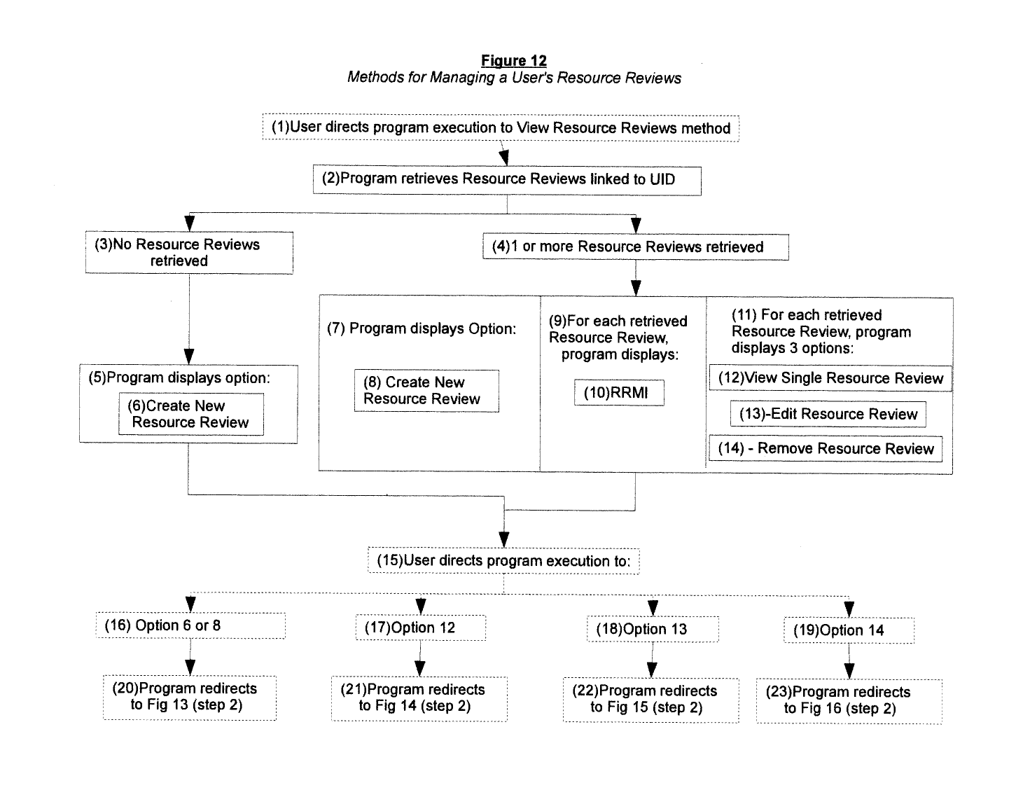

Referring now to FIG. 12, if the user directs program execution to view Resource Reviews 1, the program attempts to retrieve Resource Reviews linked to the User ID 2.

If there are no Resource Review ID's linked to the User ID 3, the invention displays the option to create a new Resource Review 6.

If there are one or more Resource Review ID's linked to the User ID 4, the invention also displays the option to create a new Resource Review 8 as well as the Meta Information of each retrieved Resource Review 10 and options for further interaction with each retrieved Resource Review.

Displayed options for further interaction with each retrieved Resource Reviews comprise: View Resource Review 12, Edit Resource Review Meta Information 13, and Remove Resource Review 14.

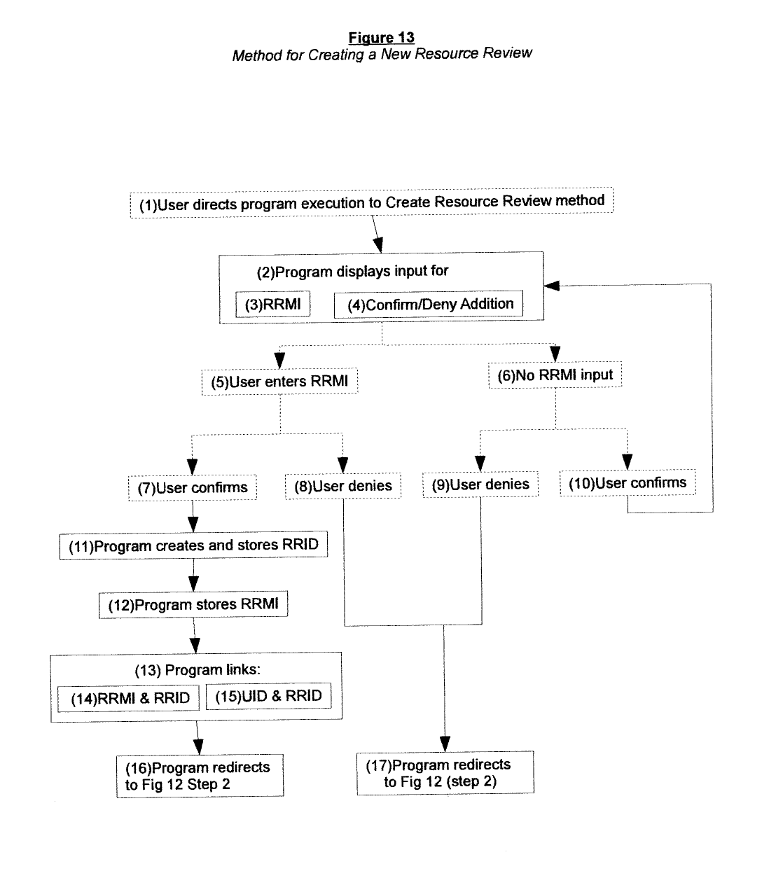

If the user directs program execution to create a new Resource Review 16, the program directs execution 20 to that method as described in 2 (FIG. 13).

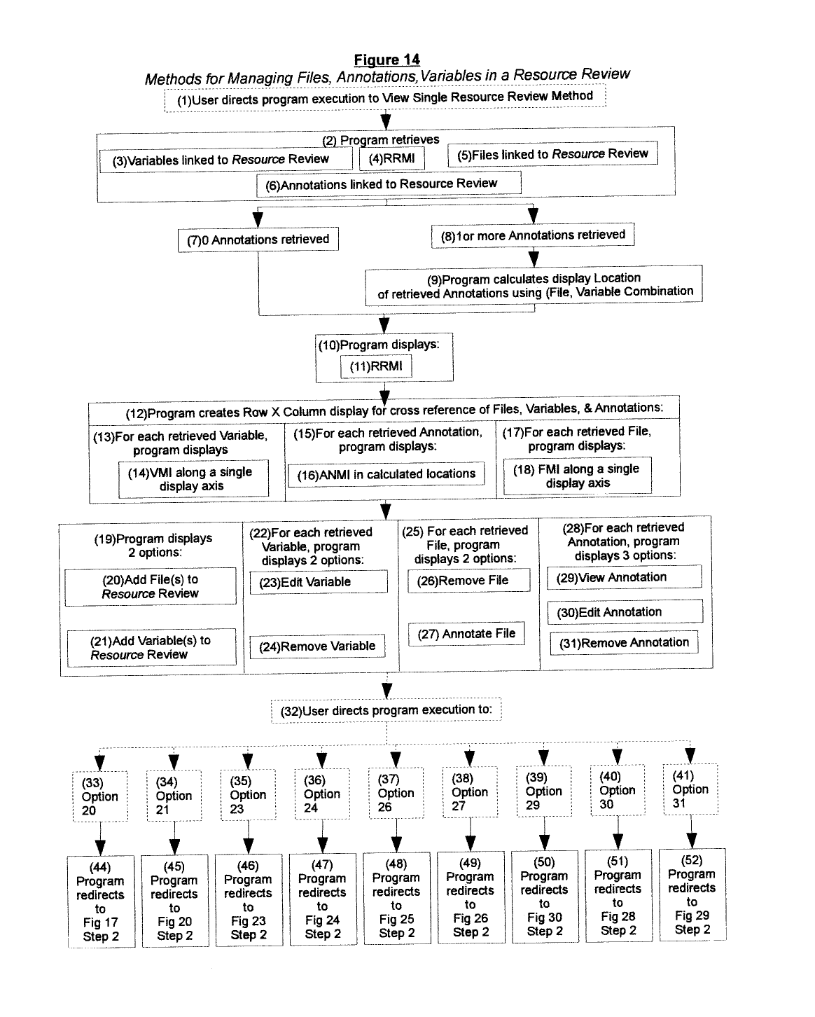

If the user directs program execution to View a Resource Review 17, the program directs execution 21 to that method as described in 2 (FIG. 14).

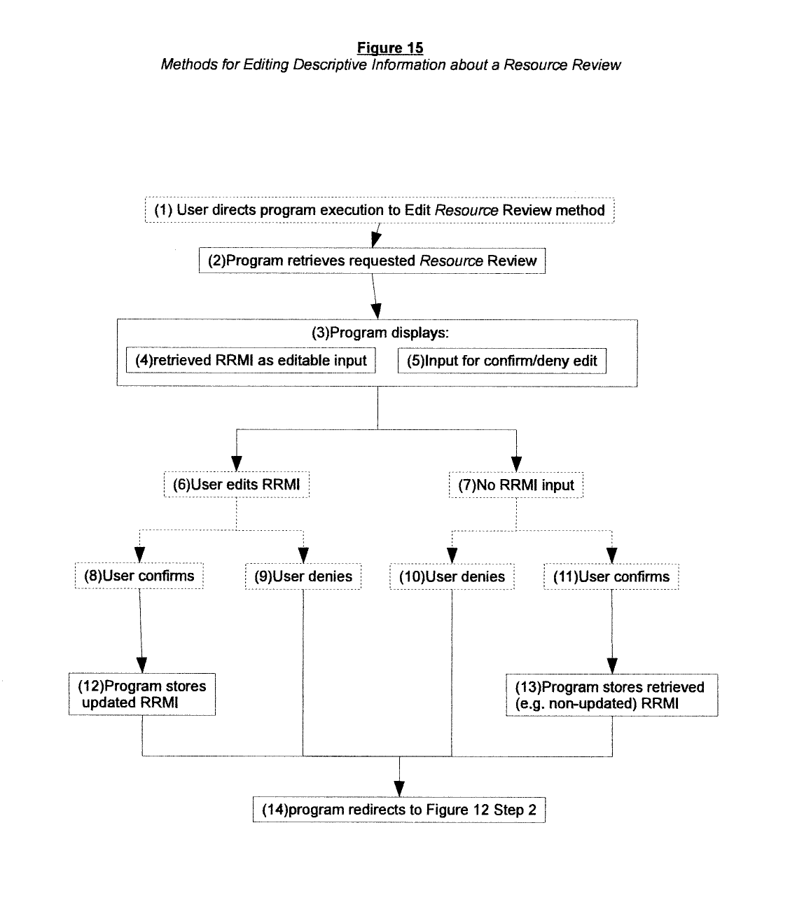

If the user directs program execution to Edit Resource Review Meta Information 18, the program directs execution 22 to that method as described in 2 (FIG. 15).

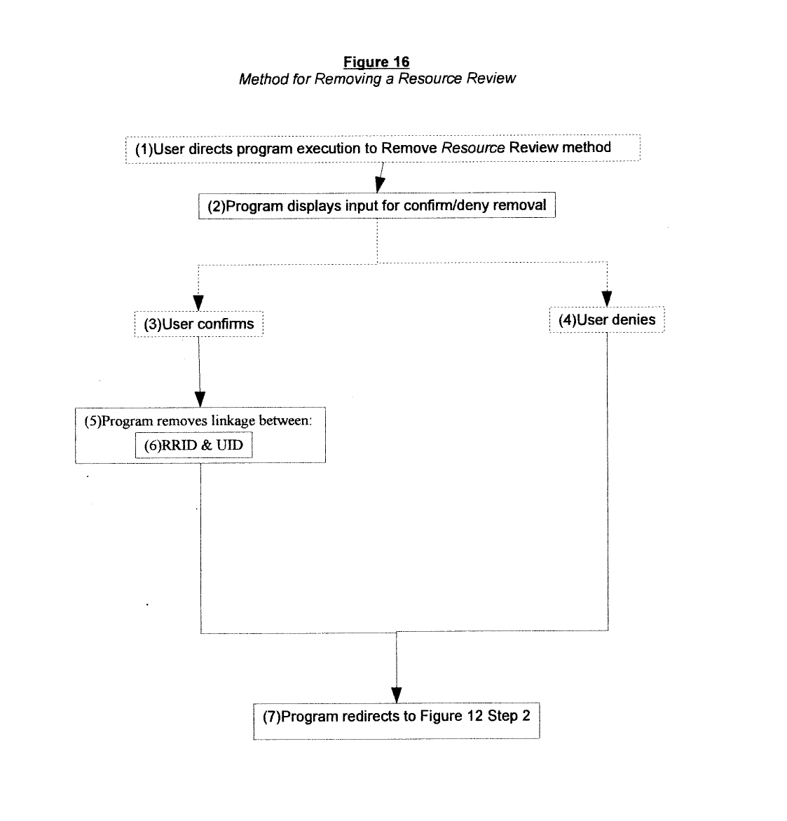

If the user directs program execution to Remove a Resource Review 19, the program directs execution 23 to that method as described in 2 (FIG. 16).

B. Creation of a New Resource Review.

Referring now to FIG. 13, if the user directs program execution to create a new literature review 1, the invention displays input for Resource Review Meta Information 3, as well as to accept or deny its creation 4.

If the User inputs Resource Review Meta Information 5 and accepts creation of the Resource Review 7, the invention creates and stores a new Resource Review ID 11.

The invention then stores the Resource Review Meta Information 12.

The program then links the Resource Review ID and Resource Review Meta Information 14 for the purpose of retrieval of Resource Review Meta Information referenced by the Resource Review ID.

It also links the Resource Review ID and the User ID (15) for the purpose of retrieval of linked Resource Review ID's and their subsequent linkages through reference to the User ID.

Following these storages and linkages, in the current embodiment of the invention, the invention directs program execution to the View Resource Reviews method as described in FIG. 12. In another embodiment, the invention could redirect to any point within the invention with the end result fulfilling the purposes described above and allowing the user to further interact with the invention.

The User can deny creation of the Resource with 8 or without 9 entering Resource Review Meta Information. If the user chooses to deny creation of the Resource Review 8 or 9 the program redirects to the View Resource Reviews Method as described in FIG. 12. In another embodiment, the invention could redirect to any point within the invention with the end result fulfilling the purposes described above and allowing the user to further interact with the invention.

C. Editing Resource Review Meta Information.

Referring again to FIG. 12, another way to interact with retrieved Resource Reviews is to edit their Meta Information retrieved in 2 and displayed in 10. After the invention displays the option to edit Meta Information of a given Resource Review 13, users may direct program execution to that option 18.

Referring now to FIG. 15, if the user directs program execution to edit Resource Review Meta Information 1, the invention retrieves stored Resource Review Meta Information by referencing the requested Resource Review ID 2.

The invention then displays 3 an editable input version of the retrieved Meta Information 4 and the ability to confirm or deny the edit 5. The user can then edit the input 6, leave it the same 7, and confirm 8 or 11 or deny 9 or 10 the edit.

The user may choose to deny the edit with 9 or without 10 editing the Meta Information. If the user chooses to deny the edit 9 or 10, the program directs execution 14 to the View Resource Reviews Method as described in FIG. 12.

If the user edits the Meta Information 6 and accepts the edit 8, the invention stores the updated Meta Information 12. The purpose of this step is to change the existing Meta Information. In another embodiment of the invention, the program may check for and store only the differences between the original information and the updated information such that the new information is displayed and a log of changes is kept.

If the user does not edit the Meta Information 7 and accepts the edit 11, the program re-stores the original, non-updated Meta Information 13. The purpose of this step is to leave the existing meta-information intact.

Following this storage 12 or 13, in the current embodiment of the invention, the invention then directs execution to the View Resource Reviews Method as described in FIG. 12. In another embodiment, the invention could redirect to any point within the invention with the end result fulfilling the purposes described above and allowing the user to further interact with the invention.

D. Removing a User's Resource Review.

Referring again to FIG. 12, another way to interact with retrieved Resource Reviews is to Remove the Resource Review. After the invention displays the option to Remove a Resource Review 14, users may direct program execution to that option 19.

Now referring to FIG. 16, if a user directs program execution to the remove Resource Review method 1, the program displays input for confirmation and denial of removal 2.

If the user confirms removal 3 the program removes the linkage between the Resource Review ID and User ID 6. The program then directs execution to the View Resource Reviews method described in FIG. 12.

The purposes of this step is to prevent retrieval of the Resource Review by the program's methods including but not limited to the View Resource Reviews Method and View Single Resource Review Method as well as retrieval of Files, Variables and Annotations linked to the Resource Review.

If the user denies removal of the file 4 the program directs execution to the View Resource Reviews method described in FIG. 12. The purposes of this step is to continue allowing retrieval of the Resource Review by the program's methods including but not limited to the View Resource Review Method and View Single Resource Review Method as well as retrieval of Files, Variables, and Annotations linked to the Resource Review.

In the current embodiment of the invention, the invention then goes back to retrieving the Resource Reviews linked to the User ID 2. In another embodiment, the invention could redirect to any point within the invention with the end result fulfilling the purposes described above and allowing the user to further interact with the invention.

E. Display of Files, Variables & Annotations in a Resource Review and Methods for Further Interaction with Them

Referring again to FIG. 12, another way to interact with retrieved Resource Reviews is to View the Resource Review. After the invention displays the option to View a Resource Review 12, users may direct program execution to that option 17.

Referring now to FIG. 14, if the program's execution is directed to the View Resource Review Method 1, the invention retrieves Resource Review Meta Information 4, Variables 3, Files 5, and Annotations 6 linked to the requested Resource Review ID.

For each retrieved Annotation 8, the program uses the retrieved Annotation's (File, Variable) combination to determine its display location 9.

The invention then displays the retrieved Resource Review Meta Information 11.

Using the retrieved information, the program creates and displays a Row by Column cross reference display of retrieved Files, Variables, and Annotations 12. It does this by displaying Meta Information of each retrieved File and Variable along opposing axes.

That is, the program displays meta information of each retrieved File in a position along a single axis 18. The purpose of this method of display is to create an organized reference to individual Files and for cross reference to individual Variables.

At the same time, it displays meta information of each retrieved Variable in a position along an opposing axis 14. The purpose of this display is to create an organized reference to the individual variables and for cross reference to individual Files.

Also, for each retrieved Annotation, the program uses the retrieved Annotation's calculated display location to display it in the corresponding location 16.

The program also displays two general options 19, two options for interacting with each retrieved Variable 22, two options for interacting with each retrieved File 25, and three options for interacting with each retrieved annotation 28.

The two general options comprise: Add a Variable to the Resource Review 21, and add a File to the Resource Review 20.

The two options displayed for each retrieved variable 22 comprise: Edit Variable Meta Information 23 and Remove Variable from Resource Review 24.

The two options displayed for each retrieved File 25 comprise: Annotate File 27 and Remove File from Resource Review 26.

The three options displayed for each retrieved Annotation 28 comprise: View Annotation 29, Edit Annotation 30, and Remove Annotation 30

In the current embodiment of the invention, there is not a method defined to limit or change the format of Variables or Files displayed within a Resource Review. In another embodiment of the invention, this could be implemented in any method sufficient to for the user to select the Variables and Files displayed or their format for a Resource Review.

VI. Methods for Interacting with Variables in a Resource Review.

A. Adding a Variable to a Resource Review.

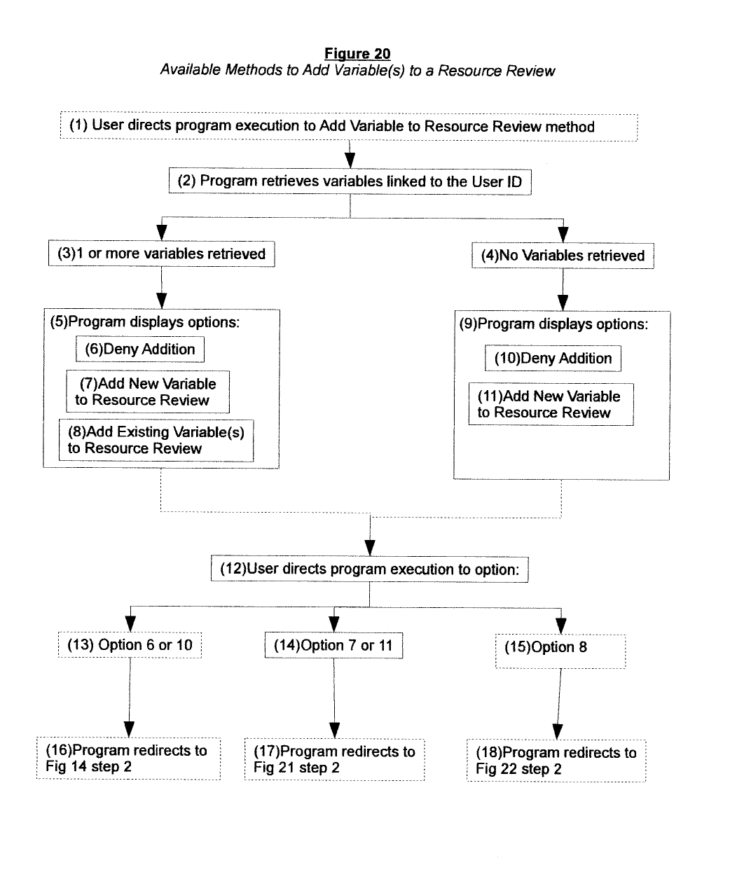

Referring again to FIG. 14, another way to interact with the retrieved Resource Review is to add a Variable to it 21. After the invention displays the option to add a Variable to the Resource Review 21, users may direct program execution to that option 34. If the user directs program execution to Add a Variable to the Resource Review, the program directs execution to the Add Variable to Resource Review method described in FIG. 20.

Referring now to FIG. 20, if users direct program execution to the Add Variable to Resource Review method 1, the program attempts to retrieve Variables linked to the User ID 2.

If there are no Variables retrieved 4, the program displays options to add a New Variable to the Resource Review 11 and to deny addition of a Variable 10.

If there is 1 or more Variables retrieved 3, the program displays the two options described above as well as the option to add an existing Variable to the literature review 8.

If the user directs program execution to deny addition 13, the program directs execution to the View Resource Review Method as described in FIG. 14.

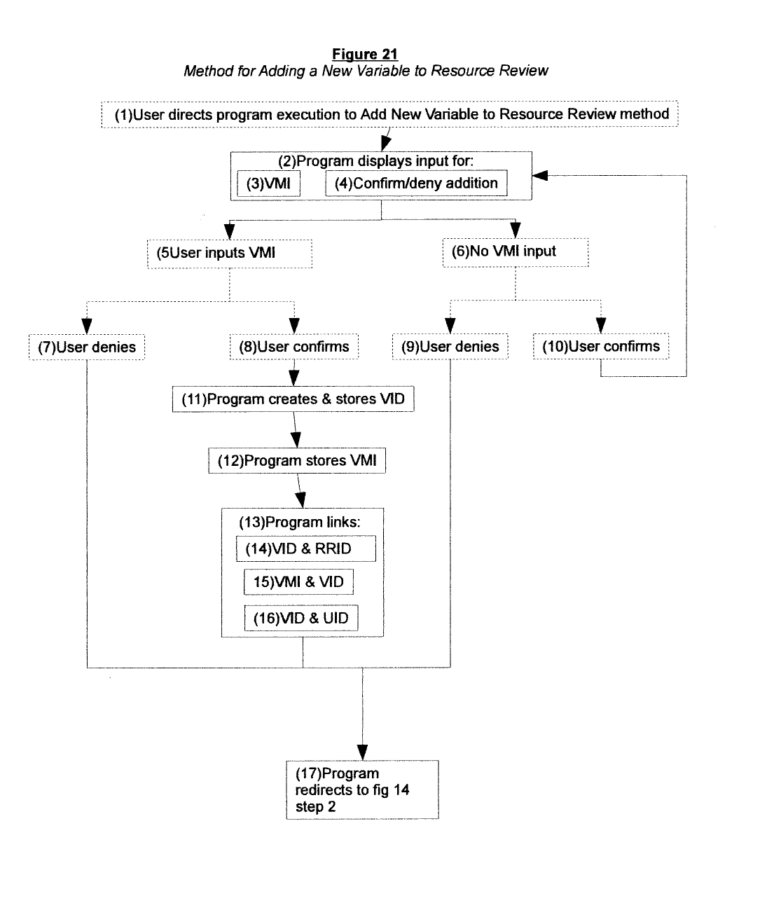

If the user directs program execution to add a new Variable to the Resource Review 14, the program directs execution to the Add New Variable to Resource Review Method as described in FIG. 21.

This method 1-17 follows all the same steps as the Add Variable to Library method described above with two differences. First, there is the addition of step 14 (FIG. 21) which links the Variable ID to the Resource Review ID. Second upon completion of this method, the program directs execution to the View Resource Review Method described in FIG. 14 as opposed to the View Library method described in FIG. 3.

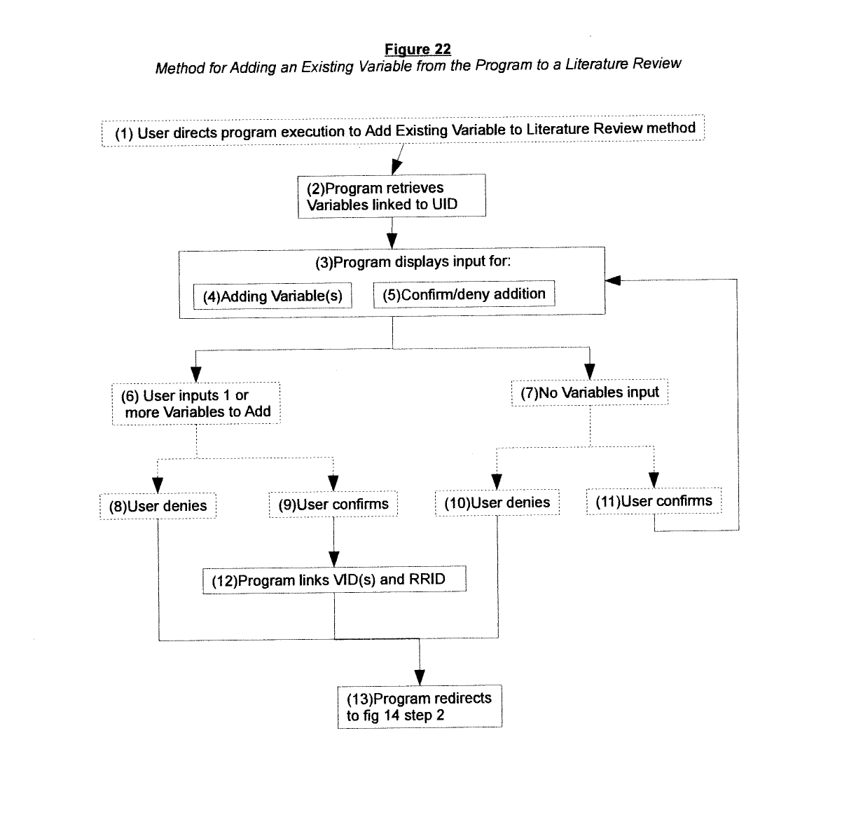

If the user directs program execution to add existing Variable to the Resource Review 15 (FIG. 20), the program directs execution to the Add Existing Variable to Resource Review Method as described in FIG. 22.

After the user directs program execution to add the existing Variable to the Resource Review 1 (FIG. 22), the program retrieves Variables linked to the User ID 2.

The program then displays input to select one or more Variables for addition 4 as well as the ability to confirm or deny addition 5.

If the user inputs one or more existing Variables from the program for addition to the resource review 6 and then confirms the addition 9, the program links the Variable ID(s) to the Resource Review ID 12. Then the program directs execution to the View Resource Review method as described in FIG. 14.

If the user denies addition with 8 or without 10 addition of one or more Variable the program directs execution to the View Resource Review method as described in FIG. 14.

If the user confirms addition without inputting one or more Variable 11, the program directs execution to the step where it retrieves Variables Linked to the User ID 2.

The purpose of these steps is to link existing Variables with the Resource Review ID and allow further execution of the program.

B. Editing a Variable in a Resource Review.

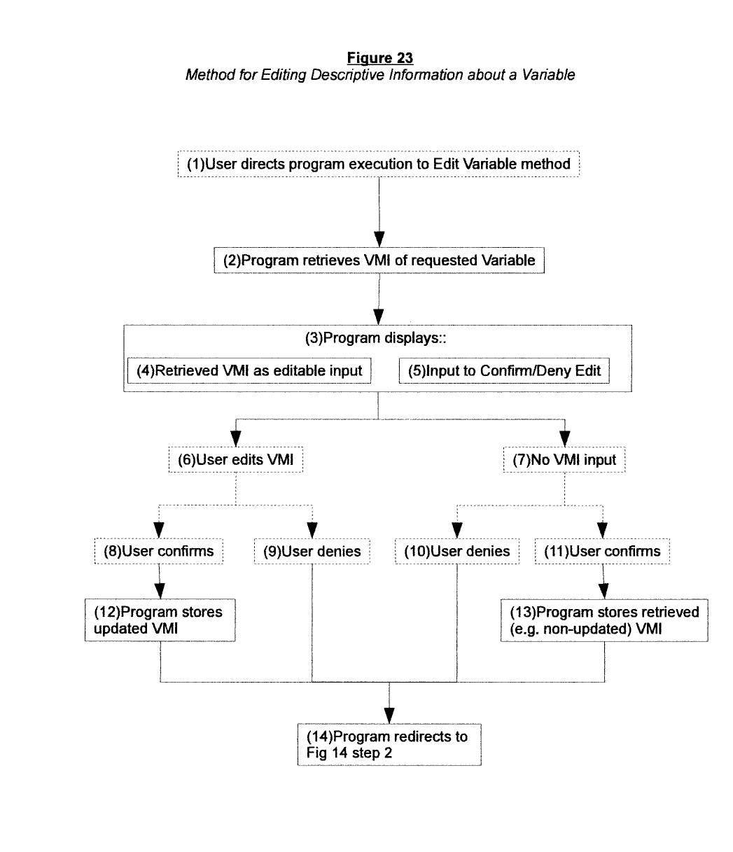

Referring again to FIG. 14, another way to interact with the retrieved Resource Review is to Edit a Variable in it 23. After the invention displays the option to Edit a Variable in the Resource Review 23, users may direct program execution to that option 35. If the user directs program execution to Edit a Variable in the Resource Review, the program directs execution to the Edit Variable Meta Information method described in FIG. 23.

This method is the same as the method of Editing Variable Meta Information in the Library (FIG. 10) except that it directs to the View Resource Review method, as described in FIG. 16, on completion 14 (FIG. 23).

C. Removing a Variable in a Resource Review.

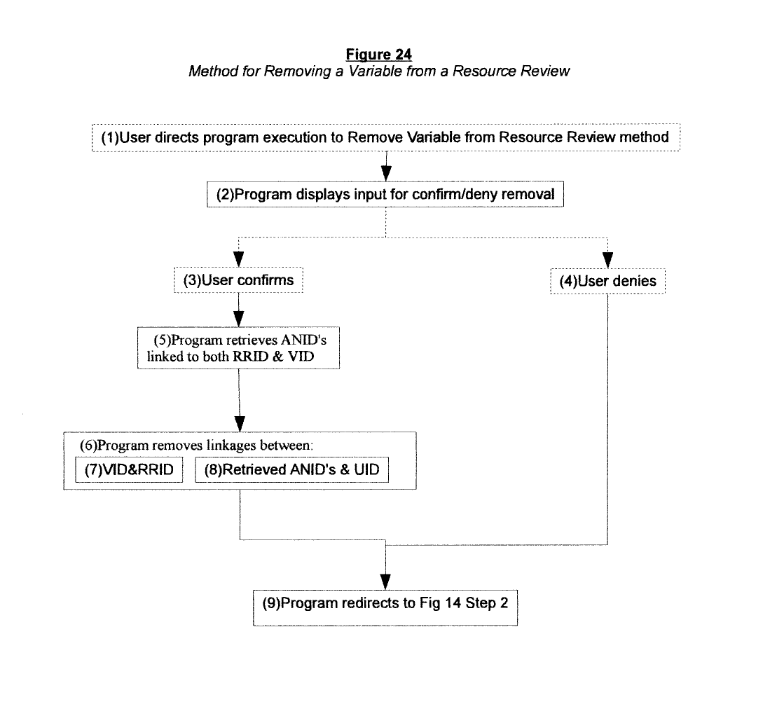

Referring again to FIG. 14, another way to interact with the retrieved Resource Review is to Remove a Variable from it 24. After the invention displays the option to remove a Variable from the Resource Review 24, users may direct program execution to that option 36. If the user directs program execution to Remove a Variable from the Resource Review, the program directs execution to that method described in FIG. 24.

If users direct program execution to the Remove Variable to Resource Review method 1 (FIG. 24), the program displays input for the user to confirm/deny removal 2.

If the user confirms removal of the file 3 the program retrieves Annotations linked to both the Variable and the Resource Review of origin for the Variable 5.

The program then removes linkages between the Variable's ID and the Resource Review ID 7. It also removes linkages between the retrieved Annotations and the User ID 8.

The program then directs execution to the View Resource Review method described in FIG. 14.

The purposes of these removals are to prevent retrieval of the Variable by the program's methods including the View Resource Review Method as well as retrieval of annotations linked to the Variable in a specific literature review.

If the user denies removal of the Variable 4 (FIG. 24) the program directs execution to the View Resource Review method described in FIG. 14. The purposes of this step is to continue allowing retrieval of the Variable by the program's methods including but not limited to the View Resource Review Method as well as retrieval of annotations linked to the Variable in a specific resource review.

In the current embodiment of the invention, the invention directs execution to the View Resource Review method described in FIG. 14. In another embodiment, the invention could redirect to any point within the invention with the end result fulfilling the purposes described above and allowing the user to further interact with the invention.

VII. Methods for Interacting with Files in a Resource Review.

A. Adding a File to a Resource Review.

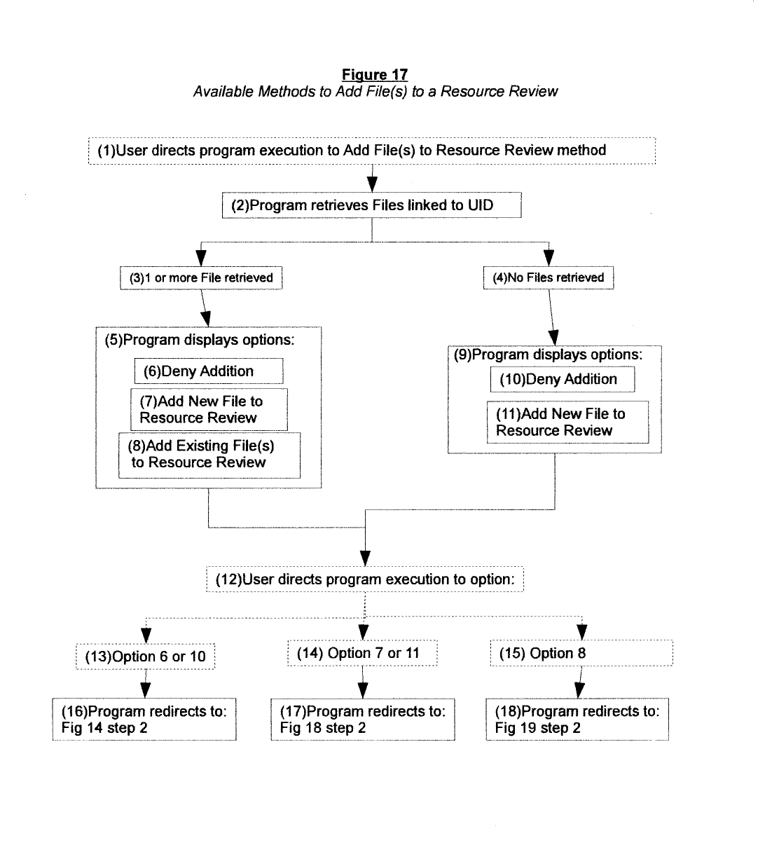

Referring again to FIG. 14, one way to interact with the retrieved Resource Review is to add a file to it 20. After the invention displays the option to add a File to the Resource Review 20, users may direct program execution to that option 33. If the user directs program execution to Add a File to the Resource Review, the program directs execution to 2 (FIG. 17).

Now referring to FIG. 17, if users direct program execution to the Add File to Resource Review method 1, the program attempts to retrieve Files linked to the User ID 2.

If there are no Files retrieved 4, the program displays options to add a New File to the Resource Review 11 and to deny addition of a File 10.

If there is 1 or more Files retrieved 3, the program displays the two options described above as well as the option to add an existing file to the resource review 8.

If the user directs program execution to deny addition 6 or 10, the program directs execution to the View Resource Review Method as described in FIG. 14.

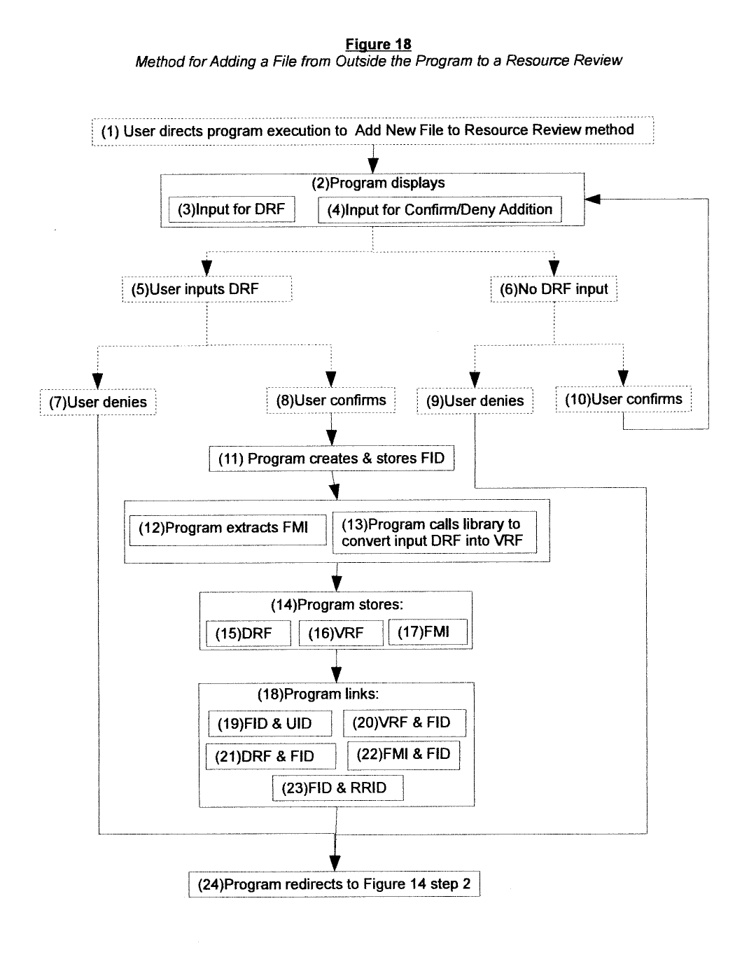

If the user directs program execution to add a new File to the Resource Review 7 or 11, the program directs execution to the Add New File to Resource Review Method as described in FIG. 18.

This method follows all the same steps as the Add File to Library method described above with two differences. First, there is the addition of step 23 (FIG. 18) which links the File ID to the Resource Review ID. Second upon completion of this method, the program directs execution to the View Resource Review Method described in FIG. 14 as opposed to the View Library method described in FIG. 3.

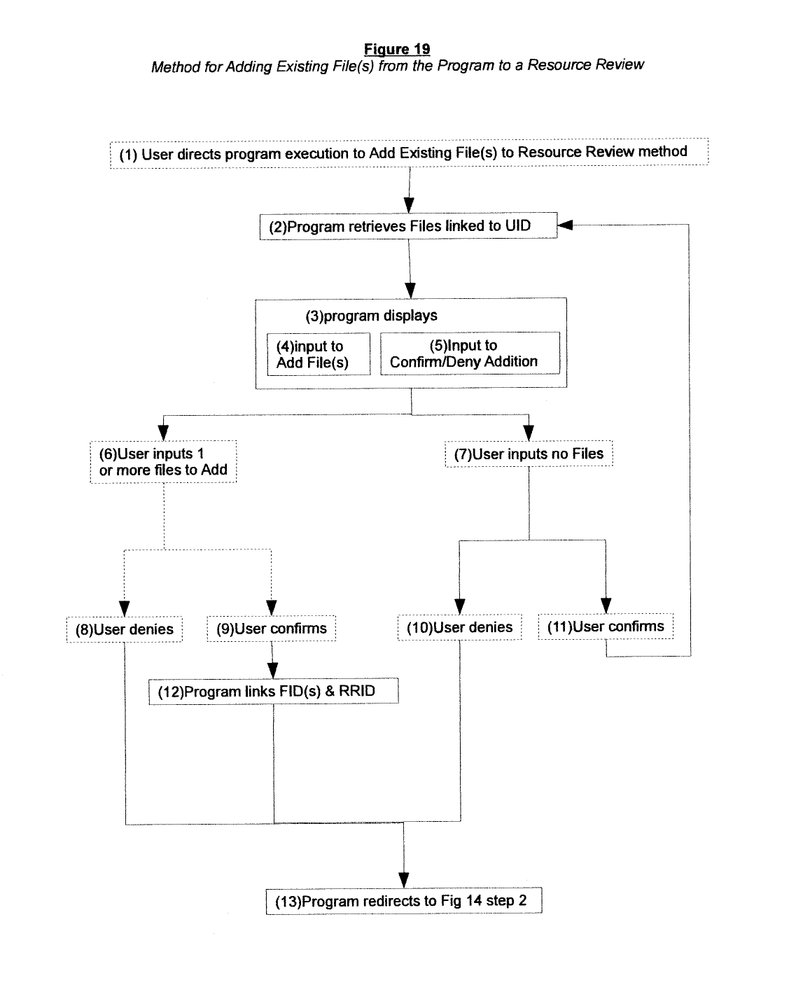

If the user directs program execution to add existing File to the Resource Review 15 (FIG. 17), the program directs execution to the Add New File to Resource Review Method as described in FIG. 19.

After the user directs program execution to add the existing File to the Resource Review 1 (FIG. 19), the program retrieves Files linked to the User ID 2.

The program then displays input to select one or more files for addition 4 as well as the ability to confirm or deny addition 5.

If the user inputs one or more existing files from the program for addition to the resource review 6 and then confirms the addition 9, the program links the File ID(s) to the Resource Review ID 12. Then the program directs execution to the View Resource Review method as described in FIG. 14.

If the user denies addition with input of one or more file 8 or without addition of one or more file 10, the program directs execution to the View Resource Review method as described in FIG. 14.

If the user confirms addition without inputting one or more file 11, the program directs execution to the step where it retrieves Files Linked to the User ID 2.

The purpose of these steps is to link existing files with the Resource Review ID and allow further execution of the program.

B. Removing a File in a Resource Review

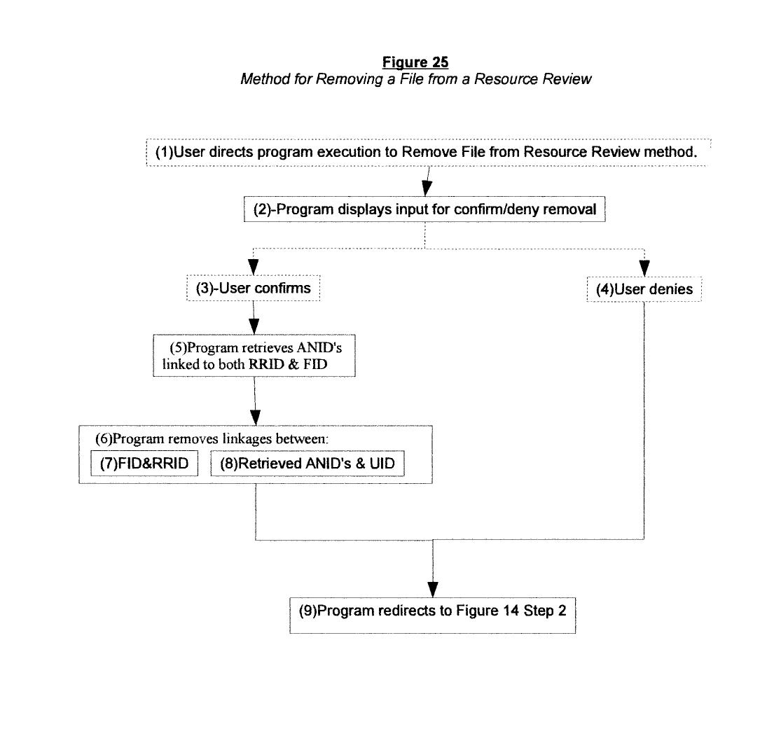

Referring again to FIG. 14, another way to interact with the retrieved Resource Review is to Remove a File from it 26. After the invention displays the option to Remove a File from the Resource Review 26, users may direct program execution to that option 37. If the user directs program execution to Remove a File from the Resource Review, the program directs execution to 2 (FIG. 25).

If users direct program execution to the Remove File to Resource Review method 1, the program displays input for the user to confirm/deny removal 2.

If the user confirms removal of the file 3 the program retrieves Annotations linked to both the File and the Resource Review of origin for the File.

The program then removes linkages between the File's ID and the Resource Review ID (7). It also removes linkages between the retrieved Annotations and the User ID (8).

The program then directs execution to the View Resource Review method described in FIG. 14.

The purposes of these removals are to prevent retrieval of the File by the program's methods including the View Resource Review Method as well as retrieval of annotations linked to the File in a specific resource review.

If the user denies removal of the file 4 (FIG. 25) the program directs execution to the View Resource Review method described in FIG. 14. The purposes of this step is to continue allowing retrieval of the File by the program's methods including but not limited to the View Resource Review Method as well as retrieval of annotations linked to the File in a specific resource review.

In the current embodiment of the invention, the invention directs execution to the View Resource Review method described in FIG. 14. In another embodiment, the invention could redirect to any point within the invention with the end result fulfilling the purposes described above and allowing the user to further interact with the invention.

C. Annotating a File in a Resource Review

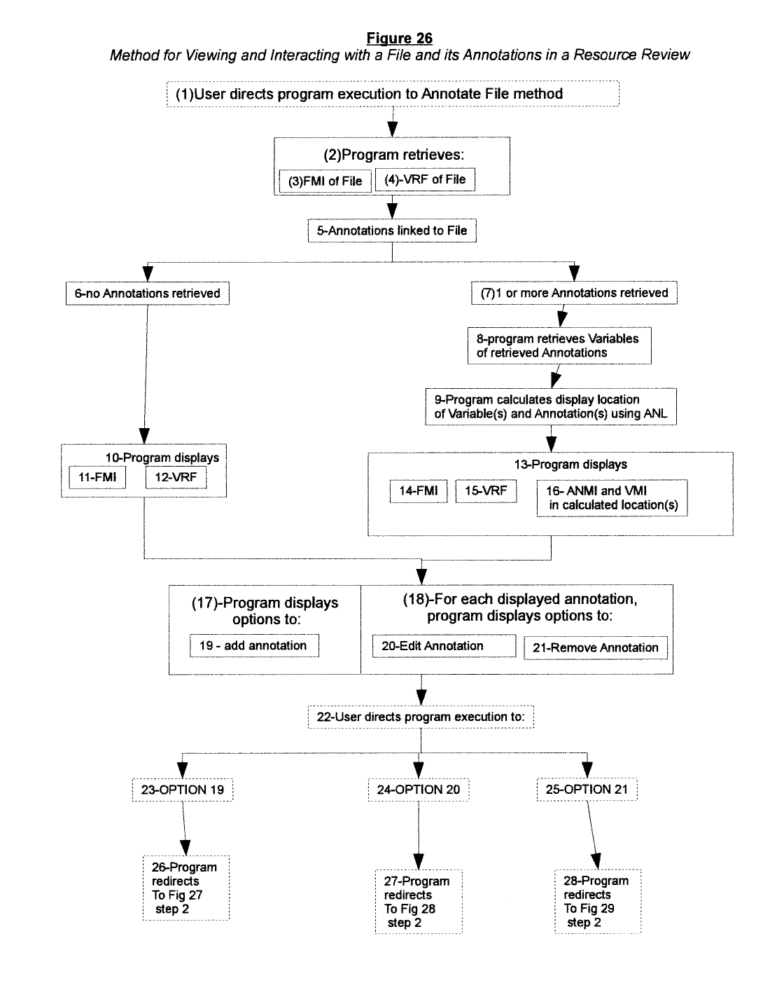

Referring again to FIG. 14, another way to interact with the retrieved Resource Review is to Annotate a File 27. After the invention displays the option to Annotate a File to the Resource Review 27, users may direct program execution to that option 38. If the user directs program execution to Annotate a File in the Resource Review, the program directs execution to the Annotate File method described in FIG. 26.

If users direct program execution to the Annotate File method 1, the program retrieves the 3 Meta Information and Visual Representation of the File 4 as well as the Annotations linked to the File 5.

If there are no Annotations retrieved 6, the program displays 10 the File Meta Information 11, the Visual Representation of the File 12, and the option to add an Annotation 19.

If there is one or more annotations retrieved 7, the program retrieves Variables linked to the retrieved Annotations 8.

The program then calculates the display location of the variable(s) and annotation(s) using the Annotation Location of the retrieved Annotations 9.

The program displays the File Meta Information 14 and Visual Representation of the File 15.

The program also displays Annotation Meta Information and Variable Meta Information of each retrieved Annotation in the calculated location 16 for the purpose of giving a reference cue as to the location referenced by the given Annotation.

The program then displays options to Add an Annotation 19. For each displayed annotation, the program displays options to Edit it 20 and Remove it 21.

The purpose of this method is to retrieve and display the File's Visual Representation, its linked annotations, and their Variables in the appropriate screen location as well as the ability to interact with these.

After the program displays the options 17 or 17 and 20 and 21 the user can direct program execution to these methods 22.

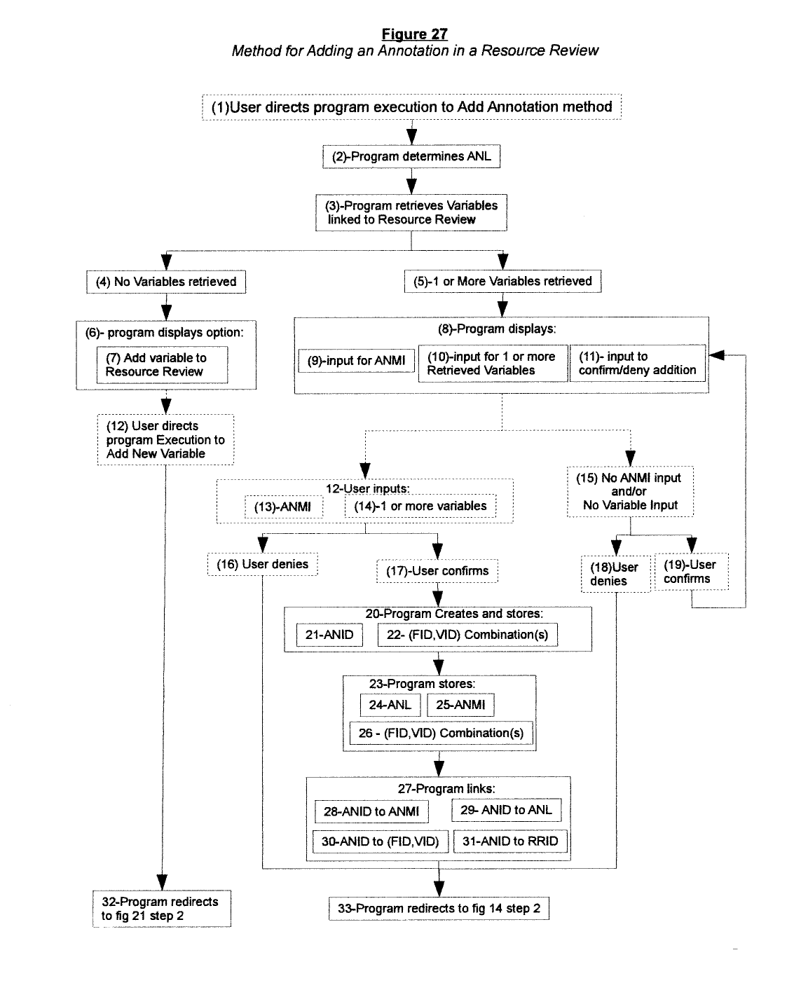

If the user directs program execution to the Add Annotation method 23, the program directs execution to that method 26 as described in FIG. 27.

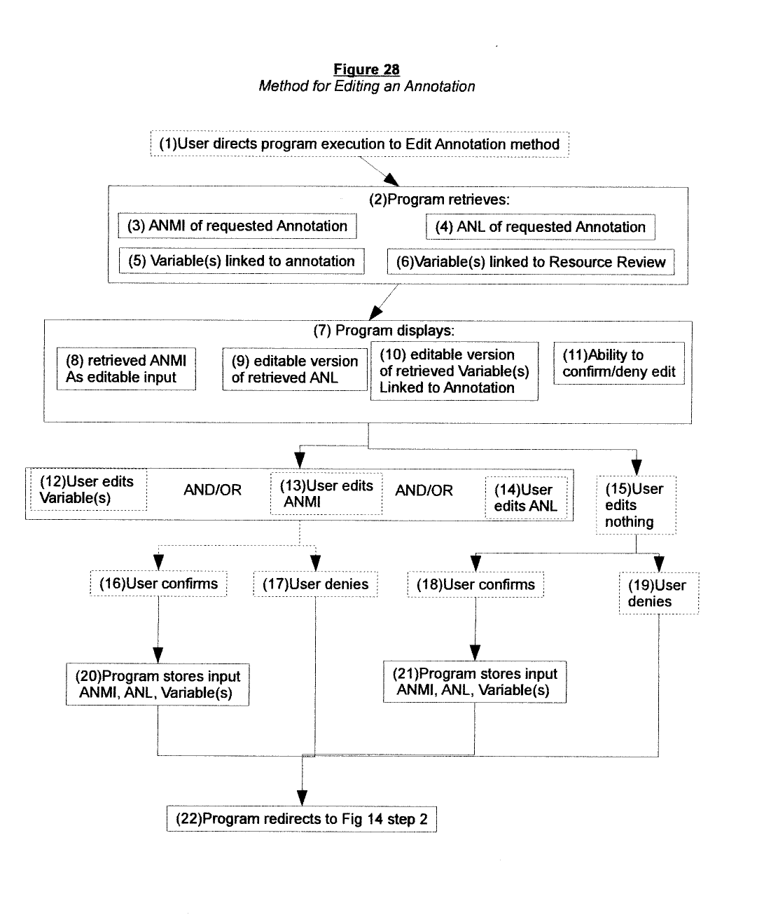

If the user directs program execution to the Edit Annotation method for an Annotation 24 (FIG. 26), the program directs execution to that method 27 as described in FIG. 28.

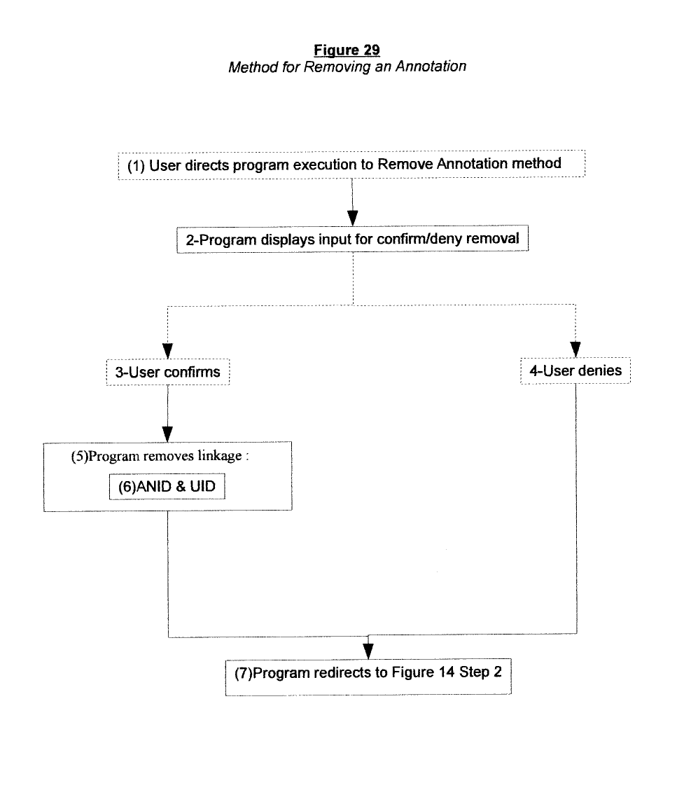

If the user directs program execution to the Remove Annotation method for an Annotation 25 (FIG. 26), the program directs execution 28 to that method as described in FIG. 29.

VIII. Methods for Interacting with Annotations in a Resource Review

A. Adding an Annotation to a File in a Resource Review

Referring now to FIG. 27, if the user directs program execution to the Add Annotation method 1, the program determines the annotation location of the Annotation for the purpose of providing a reference cue to the location of the annotation's reference when it is retrieved.

In the current embodiment, this annotation location is the page number where the annotation is added. In another embodiment, it may be a selection of text, the Cartesian coordinates of the text on the page, or any other method sufficient for the purpose of describing the location of the annotation location within the file.

The program then retrieves Variables linked the Resource Review 3.

In the current embodiment, if there are no variables retrieved 4, the program displays the option to add a variable to the Resource Review 7. The user can then direct program execution to the Add New Variable method 12 and the program directs execution to that method 31 as described in FIG. 21.

In another embodiment, the program could also allow annotations to be made without assigning a variable. In such an embodiment, these annotations could go into a “miscellaneous” category displayed separately in the View Resource Reviews method. They could then be assigned variables for categorization similar to the Edit Annotations method or manipulated for another purpose.

If there are one or more variables retrieved 5 (FIG. 27) the program displays input for Annotation Meta Information 9, input for 1 or more retrieved variables 10 and input to confirm or deny the addition 11.

The user can then input Variable Meta Information and Annotation Meta Information in any method compatible with the program. In the current embodiment, Variable meta information is limited to a selection box of retrieved variables and Annotation meta information is text input from the user. In another embodiment Annotation Meta information could include a subset of selected information from the File.

If the user denies addition of the Annotation with 16 or without 18 Meta Information or Variable Input the program directs execution 33 to the View Resource Reviews Method as described in FIG. 14.

If the user confirms addition without Meta Information or Variable Input 19 (FIG. 27), the program directs execution 19 to the display of input step 11. The purpose of this step is to ensure a valid input of a variable and some annotation meta information.

If the user inputs annotation meta information 13 and one or more Variables 14 and confirms the addition 17, the program creates and stores an Annotation ID 21 and a (File ID, Variable ID combination) 22 for the input Variable(s) and the reference File. The purpose of this step is to allow retrieval and cross referencing of the Annotation to the File and the Variable(s) in the View Resource Review step as well as anywhere the Annotation is retrieved and displayed along with its Variable or File.

The program then stores the Annotation Location 24, Annotation Meta Information 25, and the (File ID, Variable ID) combination(s) 26.

The program then links the Annotation ID to its Meta Information 28, its location 29, its (File ID, Variable ID) Combination(s) 30, and the Resource Review ID 31.

The program then directs execution 33 to the View Resource Review Method as described in FIG. 14.

B. Viewing an Annotation in a Resource Review

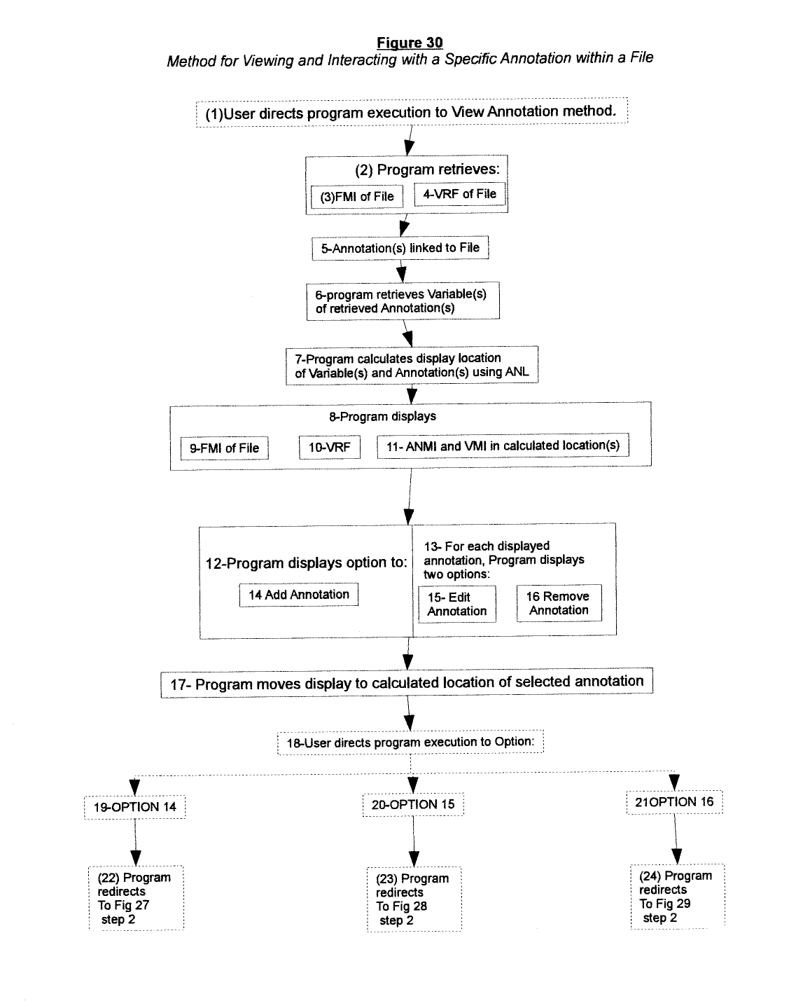

Referring again to FIG. 14, one way to interact with displayed annotations is the View Annotation method 29. If the user directs program execution to that method 39, the program directs execution 50 to that method as described in FIG. 30.

Now referring to FIG. 30, if the user directs program execution to the View Annotation Method 1, the program retrieves Meta Information 3 and the Visual Representation 4 of the File.

The program then retrieves Annotations linked to the File 5.

The program then retrieves Variables of the retrieved Annotation(s) 6.

The program calculates the display location of Variable(s) and Annotation(s) using the retrieved Annotation Location(s) 7.

The program then displays the Meta Information 9 and Visual Representation 10 of the File as well as the Meta Information of Variables and Annotations 11 in the calculated location(s) 11.

The program also displays the option to add an Annotation 14. For each displayed annotation, the program displays options to edit each Annotation 15 and Remove it 16.

The program then moves the display to the calculated location of the selected annotation 17. The purpose of this step is to facilitate interaction with the retrieved annotation.

After the program displays options 12 and 13, the user can direct program execution to options 18.

If the user directs program execution to the Add Annotation method 19, the program directs execution 22 to that method as described in FIG. 27.

If the user directs program execution to the Edit Annotation method 20, the program directs execution 23 to that method as described in FIG. 28.

If the user directs program execution to the Remove Annotation method 21, the program directs execution 24 to that method as described in FIG. 29.

C. Editing an Annotation in a Resource Review

Referring again to FIG. 14, one way to interact with displayed annotations is the Edit Annotation method 30. If the user directs program execution to that method 40, the program directs execution 51 to that method as described in FIG. 28.

Referring again to FIG. 30, one way to interact with displayed annotations is the Edit Annotation method 15. If the user directs program execution to that method 20, the program directs execution 23 to that method as described in FIG. 28.

Now referring to FIG. 28, if the user directs program execution to the Edit Annotation Method 1, the program retrieves Meta Information of 3, Location of 4, and Variable(s) linked to 5 the requested Annotation. The program also retrieves Variable(s) linked to the Resource Review 6.

The program then displays the retrieved Meta Information 8 and Location 9 of the retrieved Annotation as editable input.

The program also displays an editable version of retrieved Variable(s) linked to the Annotation 10.

The program also displays the ability to confirm or deny the edit 11.

The user can then edit the Variable 12 and/or the meta information 13 and/or the location 14.

If the user edits nothing 15 or something 12-14 and denies the edit 17 or 19 the program directs execution 22 to the View Resource Review Method as described in FIG. 14. The purpose of this step is to leave the existing meta-information intact.

If the user edits nothing 15 and confirms the edit 18 the program re-stores the input Meta Information, Variable, and Location 21 and directs execution 22 to the View Resource Review Method as described in FIG. 14. The purpose of this step is to leave the existing meta-information intact.

If the user edits the Meta Information 13 and/or the Variable 12 and/or the Location 14 and accepts the edit 16, the invention stores the updated information 20. The program then directs execution 22 to the View Resource Review Method as described in FIG. 14. The purpose of this step is to change the existing Meta Information. In another embodiment of the invention, the program may check for and store only the differences between the original information and the updated information such that the new information is displayed in a log of changes is kept.

D. Removing an Annotation in a Resource Review

Referring again to FIG. 14, one way to interact with displayed annotations is the Remove Annotation method 31. If the user directs program execution to that method 41, the program directs execution 52 to that method as described in FIG. 29.

Referring again to FIG. 30, one way to interact with displayed annotations is the Remove Annotation method 16. If the user directs program execution to that method 21, the program directs execution 24 to that method as described in FIG. 29.

Now referring to FIG. 29, if the user directs program execution to the Remove Annotation Method 1, the program displays input for confirmation/denial of removal 2.

If the user confirms removal of the Annotation 3, the program then removes the linkage between the retrieved Annotation's ID and the User ID.

The purposes of this removal is to prevent retrieval of the Annotation by the program's methods including the View Resource Review Method as well as retrieval of annotations linked to the File or Variable in a specific literature review.

The program then directs execution 7 to the View Resource Review method described in FIG. 14.

If the user denies removal of the Variable 4 the program directs execution to the View Resource Review method described in FIG. 14. The purposes of this step is to continue allowing retrieval of the Annotation by the program's methods including but not limited to the View Resource Review Method as well as retrieval of annotations linked to the File and Variable in a specific resource review.

In the current embodiment of the invention, the invention directs execution to the View Resource Review method described in FIG. 14. In another embodiment, the invention could redirect to any point within the invention with the end result fulfilling the purposes described above and allowing the user to further interact with the invention.

### IX. Options for Alternative Embodiments.

In the current embodiment, removal of a File, Variable, or Annotation within a Resource Review removes certain linkages but leaves the actual entities within the program. In the current embodiment presumably, another function could be used to then remove these entities with broken linkages. Also, a “history,” “undo” or “audit” system could be used to track and restore these changes. However the purpose of all these removal steps is to facilitate retrieval of only the appropriate entities with remaining linkages. In another embodiment, any method could be used sufficient to manage these linkages including but not limited to removing the actual entity within the program.

Additionally, in the Current Embodiment, annotations, variables, and Files are defined in a structured way but there is not a defined method to share these with other users or export them for further use and manipulation. In another embodiment, the defined structure of these entities allows any of these entities to be manipulated, shared, and exported in a variety of ways. In one embodiment this would allow the selective sharing of these entities to other users of the system

Because Files, Variables, and Annotations are the basic elements of a published Resource review or the background of a published paper, another particular embodiment would allow these elements to be manipulated and added to a text editor for the automated structuring of a bibliography and citation management system.

Because Files, Variables, and Annotations are defined in a structured way, in another particular embodiment, they could be manipulated and checked against each other using a program or manually by a computer using some sort of query language.

In the current embodiment of the invention, upon completing a number of methods, the program further directs execution of the program for the purpose of allowing further interaction with the program. In any and all of these steps, another embodiment would permit any direction of execution such that it allowed the purpose of that method to be fulfilled and to allow continued interaction with the program.

In the current embodiment, in many input steps, there is no implemented check for valid and no input by the user is considered valid “blank” input by the user. In another embodiment, a method could be implemented to validate any and/or all input steps.

In the current embodiment of the invention, there is a possibility of redundant input where users enter information more than one time. Another embodiment could optimize the process by limiting the input of information to that which is not already stored and instead merely linking to it.

In the current embodiment of the invention, users are able to add a file to the invention without adding it to a specific Resource Review. This enables them to access a limited subset of methods related to a File from the Resource Review. In another embodiment of the invention, users would not necessarily be able to add files to the invention without adding them to a Resource Review but would still be able to access the methods pertaining to a Resource Review.

In the current embodiment of the invention, there is not a defined method to input multiple new Files in parallel into the Library or a Resource Review. In another embodiment, the embodiment could contain a method end purpose being to add multiple files in parallel to the Library

In the current embodiment of the invention, there is not a defined method to input multiple new variables in parallel into the Library or a Resource Review.

In another embodiment, the embodiment could contain a method end purpose being to add multiple variables in parallel to the Resource Review.

In the current embodiment of the invention, names are ascribed to concepts for illustrative purpose. In another embodiment of the invention, the names could change without changing the underlying purpose of the concept.

In the current embodiment of the invention not all methods are described as available to Files, Variables, and Annotations from within the other methods. However, any method used for these interactions are sufficient such that they allow input of their various components, separate these inputs, and allow their various outputs.

As various changes could be made in the above constructions without departing from the scope of the invention, it is intended that all matter contained in the above description or shown in the accompanying drawings shall be interpreted as illustrative and not in a limiting sense. In particular, many functions could operate in parallel or a different order. Various implementations of the system are possible including a local computer system, a networked computer system including an internet or cloud based system, or a client-host model. Also, various methods could be used to store and retrieve files or reference files. In particular, files could be hosted locally on a computer where references to files and ID's as above could refer to memory addresses on the machine, information in database fields or tables, or as a communication protocol such as XML, SOAP, or HTTP.

Additionally, in the preceding description, numerous specific details are set forth such as examples of specific components, devices, methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication, and manufacture for those of ordinary skill. The scope of the invention should be determined by any appended claims and their legal equivalents, rather than by the examples given.

It will also be seen in the above disclosure that several of the intended purposes of the invention are achieved, and other advantageous and useful results are attained. As various changes could be made in the above constructions without departing from the scope of the invention, it is intended that all matter contained in the above descriptions or shown in the accompanying drawings shall be interpreted as illustrative and not in a limiting sense.

Terms such as “first,” “second,” and other numerical terms when used herein do not imply a sequence or order unless clearly indicated by the context.

When introducing elements or features and the exemplary embodiments, the articles “a,” “an,” “the” and “said” are intended to mean that there are one or more of such elements or features. The terms “comprising,” “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

In the preceding description, numerous specific details are set forth such as examples of specific components, devices, methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication, and manufacture for those of ordinary skill. The scope of the invention should be determined by any appended claims and their legal equivalents, rather than by the examples given.

Additionally, it will be seen in the above disclosure that several of the intended purposes of the invention are achieved, and other advantageous and useful results are attained. As various changes could be made in the above constructions without departing from the scope of the invention, it is intended that all matter contained in the above descriptions or shown in the accompanying drawings shall be interpreted as illustrative and not in a limiting sense.

Terms such as “proximate,” “distal,” “upper,” “lower,” “inner,” “outer,” “inwardly,” “outwardly,” “exterior,” “interior,” and the like when used herein refer to positions of the respective elements as they are shown in the accompanying drawings, and the disclosure is not necessarily limited to such positions. Terms such as “first,” “second,” and other numerical terms when used herein do not imply a sequence or order unless clearly indicated by the context.

When introducing elements or features and the exemplary embodiments, the articles “a,” “an,” “the” and “said” are intended to mean that there are one or more of such elements or features. The terms “comprising,” “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It will also be understood that when an element is referred to as being “operatively connected,” “connected,” “coupled,” “engaged,” or “engageable” to and/or with another element, it can be directly connected, coupled, engaged, engageable to and/or with the other element or intervening elements may be present. In contrast, when an element is referred to as being “directly connected,” “directly coupled,” “directly engaged,” or “directly engageable” to another element, there are no intervening elements present. Other words used to describe the relationship between elements should be interpreted in a like fashion (e.g., “between” versus “directly between,” “adjacent” versus “directly adjacent,” etc.).

What is claimed is:

1. A process for enabling the generation, usage, and exchange of information within a computer-stored integrated research library system comprising the steps of:
identifying unstructured information residing within a first plurality of multimedia files within electronically stored mediums wherein the unstructured information includes information that one of either does not have a pre-defined data model, is not organized in a pre-defined manner, or is not structured in a manner useful for comparison across categories;
identifying structured information residing within a second plurality multimedia files within electronically stored mediums wherein the structured information includes information that is one of either organized in a pre-defined manner, based on a pre-defined data model, or useful for comparison across categories;
generating a set of comparison indices that correlate to a research topic of interest to an end user wherein the set of indices includes the comparison topic and a set of locating data that identifies the location of the multimedia content relevant for comparison stored within an electronic medium;
an updating process by which the set of research indices are updated to verify or supplement the set of locating data that identifies the location of any multimedia content stored within an electronic medium;
generating linked data structures by transforming unstructured information into structured information by using a set of user inputs to compare at least one set of comparison categories and one set of defining annotations pertaining to each resource-comparison category combination; and
one of either exporting or importing annotations, resources, comparison categories and their associated information within one or more individuals.

2. The process for enabling the generation, usage, and exchange of information within a computer-stored integrated research library system of claim 1 further comprising the step of allowing the end user to input comparison categories and resources to generate a standard format for cross referencing resource annotations.

3. The process for enabling the generation, usage, and exchange of information within a computer-stored integrated research library system of claim 2 further comprising the steps of allowing the end user to define a set of resources to compare, to define a set of comparison categories, and to define annotations pertaining to each resource-comparison category combination.

4. The process for enabling the generation, usage, and exchange of information within a computer-stored integrated research library system of claim 3 further comprising the steps of creating, reading, updating, organizing, and deleting references to annotations, resources, comparison categories, and their associated information generated within the system.

5. The process for enabling the generation, usage, and exchange of information within a computer-stored integrated research library system of claim 4 further comprising the step of using word processing functionality for insertion and further manipulation of annotations, resources, comparison categories, and their associated information.

6. The process for enabling the generation, usage, and exchange of information within a computer-stored integrated research library system of claim 5 further comprising the step of one of either automatically or manually tracking and managing citations within a text and bibliographic entries within a text according to an identified citation style.

7. The process for enabling the generation, usage, and exchange of information within a computer-stored integrated research library system of claim 6 further comprising the step of one of either exporting or sharing annotations, resources, comparison categories, and their associated information with one or more individuals.

8. The process for enabling the generation, usage, and exchange of information within a computer-stored integrated research library system of claim 7 further comprising the step of publishing the annotations, resources, comparison categories, and their associated information as generated by the one or more individuals wherein a plurality of researchers with or without user access control may review the content of the structured information.

9. The process for enabling the generation, usage, and exchange of information within a computer-stored integrated research library system of claim 8 wherein the process for enabling the generation, usage, and exchange of information within a computer-stored integrated research library system incorporates a set of computer implemented steps and methods that are processed by a microprocessor-equipped computing device having a computer-readable storage medium.

10. The process for enabling the generation, usage, and exchange of information within a computer-stored integrated research library system of claim 9 wherein the first plurality of multimedia files and the second plurality of multimedia files include variables, annotations, and related meta information that are segregated from one another.

11. The process for enabling the generation, usage, and exchange of information within a computer-stored integrated research library system of claim 10 further comprising the step of interlinking the variables, annotations, and related meta information of the first plurality of multimedia files with the variables, annotations, and related meta information of the second plurality of multimedia files.

12. The process for enabling the generation, usage, and exchange of information within a computer-stored integrated research library system of claim 11 further comprising the step of using user access control mechanisms for creating, reading, updating, and deleting interlinking as well as references to interlinkages between interlinked data structures.

13. The process for enabling the generation, usage, and exchange of information within a computer-stored integrated research library system of claim 12 wherein an individual variable's variable meta information may comprise linkages to another variable's variable meta information.

14. The process for enabling the generation, usage, and exchange of information within a computer-stored integrated research library system of claim 13 wherein the individual variable's variable meta information includes links to at least one of either the first plurality of multimedia files and the second plurality of multimedia files.

15. The process for enabling the generation, usage, and exchange of information within a computer-stored integrated research library system of claim 14 further comprising the step of generating a visually representable form for any separate file.

16. The process for enabling the generation, usage, and exchange of information within a computer-stored integrated research library system of claim 14 further comprising the step of converting audio files into a visually representable form.

17. The process for enabling the generation, usage, and exchange of information within a computer-stored integrated research library system of claim 14 further comprising the step of reviewing comments from multiple users regarding the annotations, variables, and files included within the process for enabling the generation, usage, and exchange of information within a computer-stored integrated research library system.

18. The process for enabling the generation, usage, and exchange of information within a computer-stored integrated research library system of claim 17 further comprising the step of permitting the user to add peer review comments and ratings of the annotations, variables, and files contained within the system.
